(19) United States
(12) Patent Application Publication
(10) Pub. No.: US 2026/0349218 A1
(43) Pub. Date: Nov. 5, 2026

(54) OPTICAL SYSTEM AND CAMERA MODULE

(71) Applicant: LG INNOTEK CO., LTD., Seoul (KR)

(72) Inventors: Jin Young KIM, Seoul (KR); Ju Yong SHIM, Seoul (KR)

(73) Assignee: LG INNOTEK CO., LTD., Seoul (KR)

(21) Appl. No.: 19/645,638

(22) Filed: Apr. 13, 2026

(30) Foreign Application Priority Data
Apr. 17, 2025 (KR) 10-2025-0050496

(51) Int. Cl. G02B 13/00; G02B 3/00; G02B 9/34; G03B 30/00; H04N 23/55

(52) U.S. Cl. CPC G02B 13/004; G02B 9/34; H04N 23/55; G02B 2003/0093; G03B 30/00

(57) ABSTRACT

An optical system includes first to fourth lenses aligned on an optical axis from an object side toward a sensor side. Each of the first to fourth lenses has an object-side surface and a sensor-side surface. A power of the first lens is negative, an object-side surface of the first lens has a convex shape on the optical axis, and the object-side surface and the sensor-side surface of the first lens are spherical on the optical axis. An object-side surface and a sensor-side surface of the fourth lens are aspherical on the optical axis. A center distance between the first lens and the second lens is greater than an edge distance, and the object-side surface and the sensor-side surface of the fourth lens may have convex shapes on the optical axis.

### CROSS-REFERENCE TO RELATED APPLICATION

The present application claims priority to Korean Patent Application No. 10-2025-0050496 filed on Apr. 17, 2025, the entire contents of which is incorporated herein for all purposes by this reference.

### BACKGROUND OF THE INVENTION

### 1. Field of the Invention

The disclosure relates to an optical system and a camera module including the same.

### 2. Description of Related Art

In general, a manned or unmanned moving body includes at least one sensing device among LiDAR, a camera, radar, a laser sensor, and an ultrasonic sensor in order to recognize a surrounding environment in real time. Recently, as artificial intelligence-based image analysis technology has rapidly developed, driving technology of a moving body, so called autonomous driving technology, using only cameras, radar, ultrasonic sensors, and the like, instead of using expensive LiDAR, has attracted significant attention. For example, an autopilot system for autonomous driving captures 360-degree images within a maximum range of 250 meters using eight cameras and performs driving control through real-time image analysis. However, a plurality of cameras installed in an autonomous vehicle may have different required performance levels depending on installation position and monitoring direction. For example, in an autopilot system, three forward-facing cameras are installed in order to comprehensively monitor near and far distances. Specifically, a wide-angle camera having a maximum distance of 60 m, a main camera having a maximum distance of 150 m, and a telephoto camera having a maximum distance of 250 m are installed.

Automotive cameras are inevitably exposed to harsh conditions such as vibration, moisture, high temperature, and extreme cold. Due to temperature changes, the refractive index of each lens constituting the optical system may vary, or the spacing or position of the lenses may change slightly due to vibration, thereby causing actual optical performance to deteriorate compared to designed optical performance. In particular, in the case of cameras installed in autonomous vehicles, even slight performance degradation may lead to accidents, and therefore optical performance should be stably maintained. In addition, telephoto cameras generally have a very large total length relative to the focal length of the optical system, which may limit design freedom when mounted in a vehicle.

The most important element for forming an image in a camera is an imaging lens that forms the image. Recently, interest in high image quality and high resolution has increased, and research has been conducted on optical systems including a plurality of lenses. However, when the camera is exposed to harsh environments such as high temperature, low temperature, moisture, or high humidity inside a vehicle, optical characteristics of the optical system may change. In such a case, it may be difficult for the camera to uniformly achieve excellent optical characteristics and aberration characteristics. Accordingly, a new optical system and camera capable of solving the above-described problems are required.

### BRIEF SUMMARY

Embodiments provide an optical system and a camera module having improved optical characteristics.

Embodiments provide an optical system and a camera module having excellent optical performance in low-temperature to high-temperature environments.

Embodiments provide an optical system and a camera module capable of preventing or minimizing changes in optical characteristics.

Embodiments may be provided for cameras for vehicle interior use, exterior use, or LiDAR use.

An optical system according to an embodiment of the invention comprises, An optical system comprising first to fourth lenses aligned on an optical axis from an object side toward a sensor side, wherein each of the first to fourth lenses has an object-side surface and a sensor-side surface, wherein a power of the first lens is negative, wherein the object-side surface of the first lens has a convex shape on the optical axis, wherein the object-side surface and the sensor-side surface of the first lens are spherical on the optical axis, wherein the object-side surface and the sensor-side surface of the fourth lens are aspherical on the optical axis, wherein a center distance between the first lens and the second lens is greater than an edge distance, and wherein the object-side surface and the sensor-side surface of the fourth lens have convex shapes on the optical axis.

According to the embodiments, the object-side surface of the third lens has a concave shape on the optical axis. The sensor-side surface of the second lens has a concave shape on the optical axis, and a center distance between the second lens and the third lens is greater than a center thickness of the second lens. The second lens has a negative power on the optical axis, and the sensor-side surface of the second lens has a minimum effective diameter among effective diameters of the object-side surfaces and the sensor-side surfaces of the first to fourth lenses. The object-side surface of the first lens has a maximum effective diameter among effective diameters of the object-side surfaces and the sensor-side surfaces of the first to fourth lenses.

According to the embodiments, a composite focal length of the first lens and the second lens is negative, and an absolute value of the composite focal length of the first lens and the second lens is smaller than a composite focal length of the third lens and the fourth lens. A center thickness of the first lens is CT1, center thickness of the second lens is CT2, a center thickness of the fourth lens is CT4, and wherein the following Equation satisfies: 1<CT4/(CT1+CT2)<2. Among absolute values of radii of curvature on the optical axis of the object-side surfaces and the sensor-side surfaces of the first to fourth lenses, the absolute value of the radius of curvature of the object-side surface of the second lens is greatest.

An optical system according to the embodiments comprises first to fourth lenses aligned on an optical axis from an object side toward a sensor side, each of the first to fourth lenses has an object-side surface and a sensor-side surface, a power of the first lens is negative, wherein an object-side surface of the first lens has a convex shape on the optical axis, the first lens is a spherical glass lens, the fourth lens is an aspherical glass lens, a center distance between the first lens and the second lens is greater than an edge distance, a center thickness of the third lens is greater than center thicknesses of the first lens and the second lens, and an object-side surface and a sensor-side surface of the fourth lens have convex shapes on the optical axis.

According to the embodiment, the third lens has a positive power and the fourth lens has a positive power. The object-side surface of the third lens has a concave shape on the optical axis, the sensor-side surface of the second lens has a concave shape on the optical axis, and the center distance between the second lens and the third lens is greater than the center thickness of the second lens.

According to the embodiment, the second lens has a negative power on the optical axis, wherein the sensor-side surface of the second lens has a minimum effective diameter among effective diameters of the object-side surfaces and the sensor-side surfaces of the first to fourth lenses, and the object-side surface of the first lens has a maximum effective diameter among effective diameters of the object-side surfaces and the sensor-side surfaces of the first to fourth lenses. A center thickness of the fourth lens is thicker than center thicknesses of the first lens to the third lens. A focal length of the first lens is smaller than focal lengths of the second lens to the fourth lens, a composite focal length of the first lens and the second lens is negative, and an absolute value of the composite focal length of the first lens and the second lens is smaller than a composite focal length of the third lens and the fourth lens. A refractive index of the first lens is greater than 1.70, and a center thickness of the fourth lens is thicker than a sum of center thicknesses of the first lens and the second lens.

According to the embodiments, a center thickness of the fourth lens is CT4, a center thickness of the third lens is CT3, an optical-axis distance from a center of an object-side surface of the first lens to a surface of an image sensor is TTL, and the following Equation satisfies: 2<TTL/(CT4+CT3)<5.

A camera module according to embodiments of the present invention comprises a cover glass; an image sensor; a first lens group adjacent to the cover glass and aligned on an optical axis and having a spherical lens and an aspherical lens; and a second lens group disposed between the first lens group and the image sensor and aligned on the optical axis and having a spherical lens and an aspherical lens, wherein the cover glass is disposed between an object and the first lens group, wherein a power of the first lens group is negative, wherein a power of the second lens group is positive, wherein, in the first lens group, an object-side surface of a first lens closest to the cover glass has a convex shape on the optical axis, wherein an object-side surface and a sensor-side surface of the first lens are spherical on the optical axis, wherein a center distance between the first lens group and the second lens group is greater than an edge distance and is greatest among center distances between lenses of the first lens group and the second lens group, and wherein an object-side surface and a sensor-side surface of a last lens closest to the image sensor have convex shapes on the optical axis.

According to embodiments, lenses of the first lens group and the second lens group are made of glass, and a center distance between the cover glass and the first lens is smaller than the center distance between the first lens group and the second lens group. An optical-axis distance from a center of an object-side surface of the first lens to a surface of the image sensor is TTL, an optical-axis distance from a sensor-side surface of a last lens closest to the image sensor to a surface of the image sensor is BFL, and the following Equations satisfy: 20 mm<TTL<60 mm and 2<TTL/BFL<10. The first lens group includes a first lens and a second lens, the second lens group is disposed on a sensor side of the second lens and includes a third lens and a fourth lens, wherein a power of the first lens is negative, the first lens is made of glass, the fourth lens is a last lens and is made of glass, a center thickness of the third lens is greater than center thicknesses of the first lens and the second lens, and, among absolute values of radii of curvature on the optical axis of the object-side surfaces and the sensor-side surfaces of the first lens to the fourth lens, a radius of curvature of an object-side surface of the second lens is greatest.

The optical system and camera module according to embodiments may have improved optical characteristics. Specifically, the plurality of lenses included in the optical system may have predetermined thicknesses, powers, and distances relative to adjacent lenses. Accordingly, the optical system and camera module may have improved MTF characteristics, aberration control characteristics, and resolution characteristics within a predetermined field of view range, and may have excellent optical performance in peripheral regions of the field of view.

In addition, the optical system and camera module of the embodiments may maintain excellent optical performance within a temperature range of a moving body such as a vehicle. The plurality of lenses included in the optical system of the embodiments may have predetermined materials, powers, and refractive indices. Accordingly, even when focal lengths of respective lenses vary due to refractive index changes caused by temperature variations, the lenses may compensate for each other. Thus, the optical system may effectively distribute power within the temperature range of the moving body and may prevent or minimize changes in optical characteristics within the temperature range. Accordingly, the optical system and camera module may maintain improved optical characteristics over various temperature ranges.

Further, through a combination of aspherical lenses and spherical lenses, the optical system may satisfy a predetermined field of view and implement excellent optical characteristics. As a result, the optical system may provide a slimmer vehicle camera module. Therefore, the optical system and camera module may be provided in various applications and devices and may maintain excellent optical characteristics even under harsh temperature environments, such as exposure to an exterior of a vehicle or high temperatures inside a vehicle during summer.

Embodiments may improve reliability of cameras for vehicle interior use, exterior use, or LiDAR use.

### BRIEF DESCRIPTION OF THE DRAWINGS

FIG. 1 is a side cross-sectional view of an optical system and a camera module including the same according to an embodiment.

FIG. 2 is a side cross-sectional view for explaining a relationship between an n-th lens and an (n−1)-th lens of FIG. 1.

FIG. 3 is a table showing lens characteristics of the optical system of FIG. 1.

FIG. 4 is a table showing aspherical coefficients of the n-th lens of the optical system of FIG. 1.

FIG. 5 is a table showing thicknesses of respective lenses and distances between adjacent lenses in the optical system of FIG. 1.

FIG. 6 is a graph showing diffraction MTF data of the optical system of FIG. 1.

FIG. 7 is a graph showing aberration characteristic data of the optical system of FIG. 1.

FIG. 8 is a table showing relative illumination data according to image sensor height of the optical system according to an embodiment.

FIG. 9 is a block diagram showing a sensor system including the optical system of FIG. 1.

FIG. 10 illustrates an example of measuring an object in a vehicle including the sensor system according to the invention.

FIG. 11 illustrates an example of surrounding monitoring in a vehicle including the sensor system according to the invention.

### DETAILED DESCRIPTION

Hereinafter, preferred embodiments of the present invention will be described in detail with reference to the accompanying drawings. The technical idea of the present invention is not limited to some embodiments described herein, and may be implemented in various different forms. Within the scope of the technical idea of the present invention, one or more components of the embodiments may be selectively combined or substituted. In addition, terms used in the embodiments of the present invention (including technical and scientific terms) may be construed as meanings generally understood by those of ordinary skill in the art to which the present invention pertains, unless clearly and specifically defined otherwise, and terms generally used like terms defined in dictionaries may be interpreted in consideration of their contextual meanings in the related art.

Terms used in the embodiments of the present invention are for describing the embodiments and are not intended to limit the present invention. In this specification, singular forms may include plural forms unless expressly stated otherwise, and when described as “at least one of A and B and C (or one or more),” it may include at least one of all possible combinations of A, B, and C. In addition, in describing components of embodiments of the present invention, terms such as first, second, A, B, (a), and (b) may be used. These terms are only for distinguishing one component from another and do not limit the essence, order, or sequence of the corresponding component. Further, when a component is described as being “connected,” “coupled,” or “joined” to another component, it includes not only a case where the component is directly connected, coupled, or joined to the other component, but also a case where the component is connected, coupled, or joined by another component interposed therebetween. In addition, when described as being formed or disposed “on (above)” or “under (below)” each component, “on (above)” or “under (below)” includes not only a case where two components are in direct contact with each other but also a case where one or more other components are formed or disposed between the two components. Also, when expressed as “on (above)” or “under (below),” it may include a meaning of both an upward direction and a downward direction with respect to one component.

In the description of the invention, an “object-side surface” may refer to a surface of a lens facing an object with respect to an optical axis OA, and a “sensor-side surface” may refer to a surface of a lens facing an image sensor with respect to the optical axis. A lens surface being convex may refer to a convex shape in an optical axis or a paraxial region, and a lens surface being concave may refer to a concave shape in the optical axis or the paraxial region. In tables describing lens data, radii of curvature, center thicknesses, and optical-axis distances between lenses may refer to values on the optical axis in units of mm. A vertical direction may refer to a direction perpendicular to the optical axis, and an edge of a lens or a lens surface may refer to an edge of an effective region of the lens through which incident light passes. A size of an effective diameter of a lens surface may have a measurement error of up to about ±0.4 mm depending on a measurement method. The paraxial region refers to a very narrow region near the optical axis, and is a region where a distance of a ray from the optical axis OA is almost zero. Hereinafter, the meaning of the optical axis may include a center of each lens or a very narrow region near the optical axis.

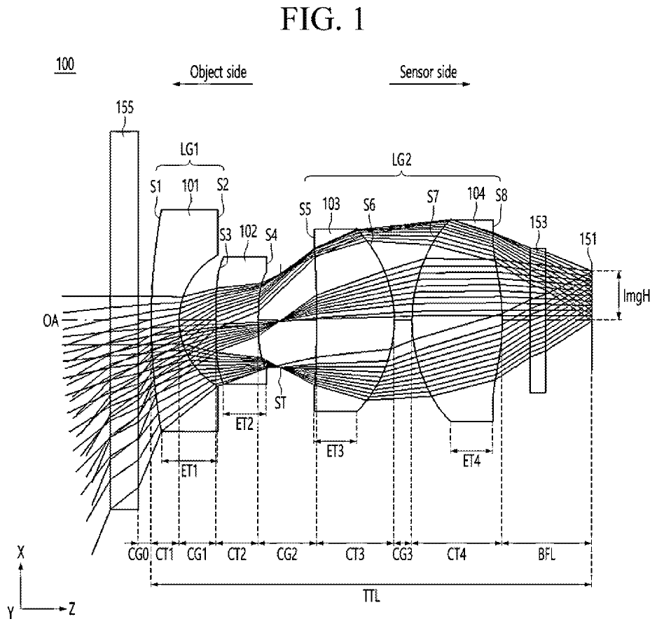

As shown in FIG. 1, an optical system 100 according to an embodiment of the invention may include a plurality of lens groups LG1 and LG2. Specifically, each of the plurality of lens groups LG1 and LG2 includes at least one lens. A first lens group LG1 and a second lens group LG2 may be sequentially disposed along an optical axis OA from an object toward an image sensor 151.

The number of lenses in each of the first lens group LG1 and the second lens group LG2 may be the same. The number of lenses in the first lens group LG1 may be one lens or two or more lenses. The first lens group LG1 may have two or fewer lenses, and may be, for example, two lenses. The second lens group LG2 may include two or more lenses, for example, two lenses. An optical-axis distance of the first lens group LG1 may be smaller than an optical-axis distance of the second lens group LG2. The optical-axis distance of the first lens group LG1 is a distance on the optical axis OA from a first surface S1 to a fourth surface S4, and the optical-axis distance of the second lens group LG2 is a distance on the optical axis OA from a fifth surface S5 to an eighth surface S8. The optical system 100 may include n lenses, an n-th lens may be a lens closest to the image sensor 151, and an (n−1)-th lens may be a lens closest to the n-th lens. The n is an integer of 5 or less, and may be 3 to 5, or may be 4.

The first lens group LG1 may include at least one lens made of glass. Preferably, all lenses of the first lens group LG1 may be made of glass. The first lens group LG1 may provide a first lens 101 closest to the object side as a glass lens. Such glass material has a small amount of expansion and contraction depending on an external temperature change and is not easily scratched, thereby preventing surface damage. The first lens group LG1 may have a spherical lens and an aspherical lens.

The second lens group LG2 may include a plurality of lenses made of glass. The second lens group LG2 may include a spherical lens and an aspherical lens. The spherical lens may be made of glass. The aspherical lens may be made of glass or plastic, and may be, for example, made of glass. Here, a spherical lens is a lens in which an object-side surface and a sensor-side surface are spherical on the optical axis, and an aspherical lens is a lens in which an object-side surface and a sensor-side surface are aspherical. In the second lens group LG2, the aspherical lens may be a glass-mold lens. The glass-mold lens is a lens injection-molded such that glass material has an aspherical shape. Here, the optical axis OA is a center or a vertex of each lens, and the paraxial region may be around the center or the vertex of the lens surface.

The first lens group LG1 may refract light incident through the object side in an optical axis direction, and the second lens group LG2 may refract light incident through the first lens group LG1 to a peripheral portion of the image sensor 151. An interval in an optical-axis direction between the first lens group LG1 and the second lens group LG2 may be smaller than a minimum center thickness of the lenses. The optical system 100 may include a spherical lens adjacent to the object and an aspherical lens adjacent to the image sensor 151. In addition, the number of spherical lenses may be the same as the number of aspherical lenses, thereby improving assemblability or assembly efficiency with a lens barrel.

The second lens group LG2 may include at least one spherical lens and at least one aspherical lens. In the second lens group LG2, the number of aspherical lenses may be the same as the number of spherical lenses. Here, the n-th lens is a lens closest to the image sensor 151, and may be provided as an aspherical lens in order to prevent degradation in optical performance. The aspherical lens may prevent spherical aberration in the optical system 100 and may suppress occurrence of aberrations even when an effective diameter increases, thereby improving miniaturization and weight reduction of the camera module. By arranging spherical lenses and aspherical lenses in a mixed manner, the optical system 100 may enable thermal compensation in a lens barrel and may suppress degradation of optical characteristics due to temperature change. In addition, since the optical system 100 includes at least one aspherical lens, it may suppress occurrence of various aberrations.

An average Abbe number of lenses having spherical surfaces may be smaller than an average Abbe number of aspherical lenses. An average refractive index of lenses having spherical surfaces may be higher than a refractive index of an aspherical lens. Since a lens surface closest to the object is provided with a maximum effective diameter, it is possible to increase an angle of view relative to a focal length.

An Abbe number of lenses of the optical system 100 may be in a range of 20 to 50, and a refractive index may be in a range of 1.5 to 2.1. The Abbe number and the refractive index may adjust chromatic dispersion caused by the lenses. Here, a lens having a maximum refractive index may be located in the first lens group LG1. A lens having a maximum Abbe number may be located in the first lens group LG1. A refractive index of an i-th lens is Ndi, an Abbe number of the i-th lens is Adi, and a value of Ndi*Adi may be maximum when i is 1 or 2. In addition, when i is 1 or 2, a value of Ndi*Adi may be 60 or more. In the optical system 100, a lens 102 having a minimum effective diameter may satisfy a condition of 50<(Ndi*Adi)<85, and * indicates multiplication.

Among lens surfaces, a lens surface having a maximum effective diameter is spherical and may be disposed closest to the object. A lens surface S1 having the maximum effective diameter may refract incident light over an entire region and improve an incidence efficiency. That is, the lens surface S1 having the maximum effective diameter is spherical. In a lens 101 closest to the object, a difference between an effective diameter of an object-side surface and an effective diameter of a sensor-side surface may be greatest. The lens 102 having the minimum effective diameter is an aspherical lens or a glass lens. The lens 102 having the minimum effective diameter may be located on an object side of an aperture stop ST.

A lens closest to the image sensor 151 may be an aspherical lens and may be made of glass. According to an embodiment of the invention, since each lens group LG1 and LG2 includes a spherical lens and an aspherical lens, it is possible to reduce a weight of the camera module, reduce manufacturing cost, and suppress degradation of optical characteristics due to temperature change.

Each of the lenses may include an effective region and an ineffective region. The effective region may be a region through which light incident to each of the lenses passes. That is, the effective region may be defined as an effective region or an effective diameter in which incident light is refracted to implement optical characteristics. The ineffective region may be disposed around the effective region and may be defined as a flange portion. The ineffective region may be a region in which effective light does not enter each of the plurality of lenses. That is, the ineffective region may be a region irrelevant to the optical characteristics. In addition, an end of the ineffective region may be a region fixed to a lens barrel or the like that accommodates the lens.

In the optical system 100, TTL may be greater than 5 times ImgH, for example, greater than 6 times and less than 12 times. Preferably, a condition of 5<TTL/ImgH<12 may be satisfied. TTL (Total Track Length or Total Top Length) is an optical-axis distance from a center of an object-side surface S1 of the first lens 101 to a surface of the image sensor 151. ImgH is a length from a center of the image sensor 151 or the optical axis OA to an end of a effective region in a diagonal direction of the image sensor 151. The ImgH is ½ of a maximum diagonal length of the effective region of the image sensor 151.

In the optical system 100, an effective focal length (EFL) may be less than 10 mm, for example, greater than 1 mm and less than 10 mm. An angle of view of the optical system 100 may be greater than 80 degrees, and may be, for example, greater than 80 degrees and less than 160 degrees. The angle of view is an angle of view measured based on a diagonal length of the image sensor 151. In the optical system 100, the effective focal length EFL may be less than 10 mm and the angle of view FOV may be greater than 80 degrees, so that the optical system 100 may be provided as a standard optical system in an automotive camera module. That is, the optical system 100 has a wide angle of view and may reduce the focal length to less than 10 mm. For example, the optical system and camera module according to an embodiment may be applied to a camera module for LiDAR provided in a vehicle. For example, light emitted by a transmission module is reflected by an object, and the camera module receives the reflected light. Such a LiDAR camera module may be selectively applied to devices such as a collision warning avoidance system, a blind spot monitor, lane keeping assist, a lane departure warning, and adaptive cruise control, and may provide functions that assist a driver and make autonomous driving safer and more comfortable.

By setting a value of TTL/(2*ImgH) of the optical system 100 to be greater than 2.5, it is possible to provide an optical system for driver assistance. A total number of lenses in the first and second lens groups LG1 and LG2 is 5 or less, or 4 or less. The optical system 100 may provide an image without exaggeration or distortion with respect to a formed image.

A length of the image sensor 151 is a length of the effective region and is a maximum diagonal length in a direction orthogonal to the optical axis OA. In the optical system 100, the number of lenses having an effective diameter greater than a diagonal length of the image sensor 151 may be 3 or more or 4 or less. The diagonal length of the image sensor 151 may be smaller than a maximum effective diameter of the lenses. The diagonal length of the image sensor 151 may be smaller than a minimum effective diameter of the lenses. Accordingly, due to the number of glass lenses and center thicknesses of the glass lenses in the optical system 100, it is possible to reduce an influence on optical performance, that is, a change in optical performance due to a temperature change from low temperature to high temperature.

A sensor-side surface S2 of the first lens 101 closest to the object may have an effective diameter smaller than an effective diameter of a sensor-side surface S8 of a last lens 104 closest to the image sensor 151. Accordingly, a center thickness CT1 of the first lens 101 of the optical system 100 may be provided thinner than a center thickness CT4 of the last lens 104, and a refraction angle and chromatic dispersion may be adjusted. Accordingly, in the optical system 100, it is possible to compensate for resolution and degradation of optical characteristics due to temperature change, improve chromatic aberration control characteristics, and improve vignetting characteristics of the optical system 100.

The optical system 100 may include an aperture stop ST that adjusts an amount of incident light. The aperture stop ST may be disposed around a space between adjacent lenses. The aperture stop ST may be disposed around a space between the first lens group LG1 and the second lens group LG2. Here, the aperture stop ST may be a light-blocking film or a light-blocking layer coated on an ineffective surface of a lens. As another example, the aperture stop ST may be a spacer. Specifically, a flange portion of an object-side surface or a sensor-side surface of a selected one of the lenses among the lenses of the optical system 100 may perform a role of an internal aperture stop that adjusts an amount of light. In lenses disposed between the object and the aperture stop ST, as approaching from the object to the aperture stop ST, an average effective diameter of the lenses tends to decrease. Here, the average effective diameter is an average of effective diameters of an object-side surface and a sensor-side surface of each lens.

A center distance CG2 between the first lens group LG1 and the second lens group LG2 may be a distance in an optical axis direction between a sensor-side surface S4 of the first lens group LG1 and an object-side surface S5 of the second lens group LG2. The center distance CG2 between the first and second lens groups LG1 and LG2 may be a center distance between an adjacent aspherical lens and a spherical lens. The center distance CG2 between the first and second lens groups LG1 and LG2 may be greater than center distances between lenses within the second lens group LG2.

Here, the first lens group LG1 includes lenses located on an object side from the aperture stop ST, and the second lens group LG2 may include lenses located on a sensor side from the aperture stop ST. The first lens group LG1 and the second lens group LG2 may be divided into an object-side lens group and a sensor-side lens group with respect to the aperture stop ST. The sensor-side surface S4 of the first lens group LG1 and the object-side surface S5 of the second lens group LG2 may face each other. The sensor-side surface S4 of the first lens group LG1 is concave on the optical axis OA, and the object-side surface of the second lens group LG2 may have a concave shape on the optical axis OA. An optical-axis distance between the last lens 104 and the image sensor 151 is BFL, and the BFL may be greater than a center thickness of lenses adjacent to the aperture stop ST, and may be 5 mm or more.

The first lens group LG1 may have negative power, and the second lens group LG2 may have positive power. In the first lens group LG1, a lens closest to the object side has negative power, and among the lenses of the second lens group LG2, a lens closest to the sensor side may have positive power. When a focal length of the first lens group LG1 is FLG1 and a focal length of the second lens group LG2 is FLG2, a condition of |FLG1|<FLG2 may be satisfied. In the optical system 100, the number of lenses having negative power may be the same as the number of lenses having positive power. When three or more glass lenses are disposed in the camera module, durability and heat resistance are improved, occurrence of internal stress in a lens manufacturing process may be suppressed, and degradation in optical performance may be prevented. In addition, chromatic aberration at a high refractive index may be improved by the glass lenses.

A sum of refractive indices of the lenses is 9 or less, for example, in a range of 6 to 9, and an average refractive index may be 1.6 or more, for example, in a range of 1.6 to 1.8. A sum of Abbe numbers of the lenses may be 190 or less, for example, in a range of 110 to 190, and an average Abbe number may be 45 or less, for example, in a range of 20 to 45. A sum of center thicknesses of all lenses may be 12 mm or more, for example, in a range of 12 mm to 20 mm, or in a range of 14 mm to 18 mm. An average of the center thicknesses of all lenses may be 3 mm or more, for example, in a range of 3 mm to 5 mm. A sum of center distances between lenses on the optical axis OA is 5 mm or more, for example, in a range of 5 mm to 10 mm, or in a range of 6 mm to 9 mm, and may be smaller than the sum of the center thicknesses of the lenses.

In addition, an average value of effective diameters of respective lens surfaces may be 8 mm or more, for example, in a range of 8 mm to 16 mm, or in a range of 8 mm to 13 mm. A difference between a maximum effective diameter and a minimum effective diameter among the lens surfaces may be 6 mm or more, for example, in a range of 6 mm to 15 mm. Accordingly, since lenses are provided such that an average of center thicknesses of all lenses is 3 mm or more and an average effective diameter is 6 mm or more in the optical system, assemblability between the lenses and the lens barrel may be improved.

The F-number (F #) of an optical system or a camera module according to an embodiment of the invention may be less than 2, for example, in a range of 0.1 to 1.5 or in a range of 0.1 to 1.2. Here, a horizontal field of view of the optical system is 135 degrees or less, for example, in a range of 75 degrees to 135 degrees, and may be smaller than a diagonal field of view. A vertical field of view of the optical system is 95 degrees or less, and is in a range of 60 degrees to 95 degrees, and may be smaller than the horizontal field of view. The horizontal field of view is a field of view measured based on a horizontal length of an image sensor 151, and the vertical field of view is a field of view measured based on a vertical length of the image sensor 151. The image sensor 151 may have, for example, a diagonal sensor length of 6.9 mm±0.5 mm, a sensor length in a horizontal direction Y of 6.400 mm±0.5 mm, and a sensor height in a vertical direction X of 4.80 mm±0.5 mm. Accordingly, it is possible to suppress a change in a focal imaging position due to a temperature change, and it is possible to provide an automotive camera in which various aberrations are satisfactorily corrected.

The optical system 100 or the camera module may include an image sensor 151. The image sensor 151 may detect light and convert the detected light into an electrical signal. The image sensor 151 may detect light that has sequentially passed through the lenses. The image sensor 151 may include an element capable of detecting incident light, such as a CCD (Charge Coupled Device) or a CMOS (Complementary Metal Oxide Semiconductor).

The optical system 100 or the camera module may include an optical filter 153. The optical filter 153 may be disposed between the second lens group LG2 and the image sensor 151. The optical filter 153 may be disposed between a lens closest to the sensor among the lenses and the image sensor 151. For example, the optical system 100 may be disposed between the last lens and the image sensor 151. The optical filter 153 may include an infrared filter or an infrared cut-off filter. The optical filter 153 may transmit light in a set wavelength band and filter light in other wavelength bands. When the optical filter 153 includes an infrared filter, it is possible to block radiant heat emitted from external light from being transmitted to the image sensor 151. In addition, the optical filter 153 may transmit visible light and may reflect infrared light. The optical filter 153 may transmit a wavelength of 920 nm or more, for example, a wavelength band of 920 nm to 960 nm. As another example, the optical filter 153 may transmit at least one wavelength of a LiDAR wavelength, for example, 905 nm±20 nm or 1550 nm 20 nm.

A cover glass 155 may be disposed on an object side of the first lens 101. An effective diameter of the cover glass 155 may be greater than an effective diameter of an object-side surface of the first lens 101. Accordingly, the cover glass 155 may protect the first lens 101. The cover glass 155 may protect an object-side region of the first lens 101 and may prevent degradation in reliability of the optical system 100. The cover glass 155 may be removed. A center distance CG0 between the cover glass 155 and the first lens 101 may be smaller than a center distance CG1 between the first and second lenses 101 and 102.

Since an embodiment is an optical system applied to a vehicle camera, the first lens 101 may be provided as a glass lens even when designed using an aspherical lens and a spherical lens together. This is because glass material has advantages of being resistant to scratches and being less sensitive to external temperature as compared to plastic material. Since the first lens 101 has a convex shape towards a driver in a vehicle, it is possible to more effectively prevent accumulation of foreign substances or scratches and to improve incidence efficiency. Accordingly, it is possible to improve reliability of a driver-monitoring camera module. A last lens of the optical system 100 may be provided as an aspherical lens. Since the last lens is the aspherical lens, it is possible to reduce an influence on optical characteristics. In addition, since the last lens is provided as the aspherical lens, it is possible to correct chromatic aberration and to refract light to an entire region of the image sensor 151.

The optical system 100 according to an embodiment may further include a reflective member (not shown). The reflective member may be implemented by a prism that reflects incident light of the first lens group LG1 toward the lenses. As another example, the optical system 100 may include a first reflective member disposed on an object side and a second reflective member disposed between the last lens and the image sensor 151. The reflective member is a member that changes an optical path and may reduce a thickness of the camera module.

An optical system according to an embodiment of the invention will be described.

Referring to FIGS. 1 to 3, an optical system 100 according to an embodiment may include a first lens 101 to a fourth lens 104. The first to fourth lenses 101 to 104 may be sequentially aligned along an optical axis OA. Light corresponding to information of an object may pass through the first lens 101 to the fourth lens 104 and may be incident on the image sensor 151. The first and second lenses 101 and 102 are lenses of the first lens group LG1. The third and fourth lenses 103 and 104 are lenses of the second lens group LG2, and the fourth lens 104 is closest to the image sensor 151.

Focal lengths of the first to fourth lenses 101, 102, 103, and 104 are F1, F2, F3, and F4, a composite focal length of the first and second lenses 101 and 102 is F12 or FLG1, a composite focal length of the third and fourth lenses 103 and 104 is F34 or FLG2, and the following conditions may be satisfied.

|F1|<F4<|F2| Condition 1:

|F1|<F3*2<|F2| Condition 2:

|F12|<F34 Condition 3:

|F12|<F1 Condition 4:

F34<|F1| Condition 5:

The first lens 101 may have positive or negative power on the optical axis OA. The first lens 101 may have negative power. The first lens 101 may include plastic or glass material, and may be, for example, made of glass. The first lens 101 of glass material may reduce a change in a center position and a radius of curvature by a temperature change depending on an ambient environment and may protect an incident-side surface of the optical system 100.

On the optical axis OA, a first surface S1 on an object side of the first lens 101 is convex, and a second surface S2 on a sensor side may have a concave shape. The first lens 101 may have a meniscus shape convex toward an object on the optical axis. The first lens 101 may be a spherical glass lens, and the first surface S1 and the second surface S2 may be spherical. Alternatively, on the optical axis OA, the first surface S1 may have a concave shape and the second surface S2 may have a convex shape. The first lens 101 may have a thickness of 1 mm or more, thereby preventing degradation in rigidity against an external impact, and may suppress a change in optical performance when temperature changes due to the glass material. In addition, since a spherical surface is applied to the glass material, even when the lens is designed to be thick, a change in refractive index of light may not be large. Here, the thickness of the lens may be a center thickness.

Since the first lens 101 has the first surface S1 convex and the second surface S2 concave on the optical axis, the first lens 101 may refract incident light in a direction closer to the optical axis and may reduce an effective diameter of the second lens 102.

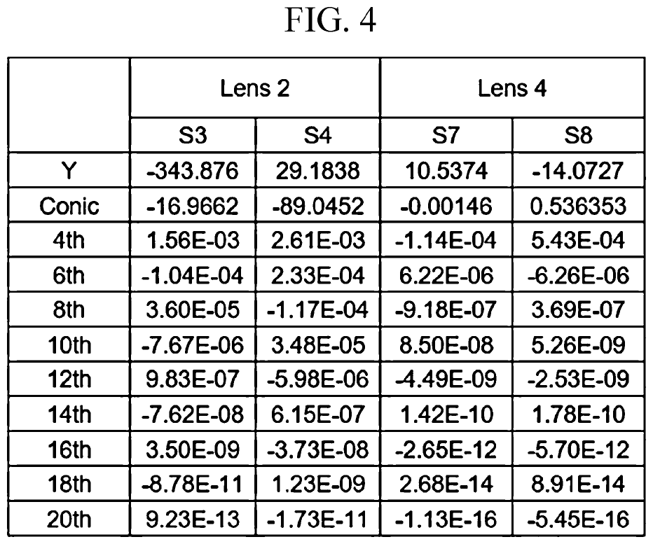

The second lens 102 may be disposed between the first lens 101 and the third lens 103. The second lens 102 may have positive or negative power on the optical axis OA and may have, for example, negative power. The second lens 102 may include plastic or glass material. For example, the second lens 102 may be provided as a glass lens. On the optical axis OA, a third surface S3 on an object side of the second lens 102 is convex, and a fourth surface S4 on a sensor side may have a concave shape. The second lens 102 may have a meniscus shape convex toward an object on the optical axis. Alternatively, the third surface S3 may be convex and the fourth surface S4 may be convex. Alternatively, the second lens 102 may have a biconcave shape. Alternatively, the third surface S3 may be concave and the fourth surface S4 may be convex. The second lens 102 may be provided as a glass aspherical lens. The third surface S3 and the fourth surface S4 are aspherical, and as shown in FIG. 4, indicate aspherical coefficients from fourth order to twentieth order, and indicate a conic constant and a radius of curvature Y.

The third lens 103 may have positive or negative power on the optical axis OA. The third lens 103 may have positive power. The third lens 103 may include plastic or glass material. For example, the third lens 103 may be a spherical glass lens. On the optical axis OA, a fifth surface S5 on an object side of the third lens 103 is concave, and a sixth surface S6 on the sensor side may have a convex shape. The third lens 103 may have a meniscus shape convex towards the sensor on the optical axis OA. Alternatively, the third lens 103 may have a meniscus shape convex towards the object side. Alternatively, the third lens 103 may have a biconvex shape or a biconcave shape. The fifth surface S5 and the sixth surface S6 of the third lens 103 may be spherical on the optical axis, and at least one or both of the fifth surface S5 and the sixth surface S6 may be provided without a critical point from the optical axis OA to an end of an effective region.

An aperture stop ST may be disposed around the sensor-side surface S4 of the second lens 102. The aperture stop ST may be disposed around a region between the second lens 102 and the third lens 103, and may be disposed closer to the second lens 102 than to the third lens 103. Since a hole diameter of the aperture stop ST is provided smaller than an effective diameter of the fourth surface S4, it is possible to adjust an amount of light passing through the second lens 102 and to suppress an increase in an effective diameter of the seventh surface S7 of the third lens 103.

The fourth lens 104 may have positive or negative power on the optical axis OA. The fourth lens 104 may have positive power. The fourth lens 104 may include plastic or glass material. For example, the fourth lens 104 may be an aspherical glass lens. As another example, the fourth lens 104 may be an aspherical plastic lens. On the optical axis OA, a seventh surface S7 on the object side of the fourth lens 104 is convex, and an eighth surface S8 on the sensor side may have a convex shape. The fourth lens 104 may have a biconvex shape on the optical axis OA. Alternatively, the fourth lens 104 may have a meniscus shape convex towards the sensor side. Alternatively, the fourth lens 104 may have a meniscus shape convex towards then object side or may have a biconcave shape.

The seventh surface S7 and the eighth surface S8 of the fourth lens 104 may be aspherical on the optical axis, and the seventh surface S7 and the eighth surface S8 are aspherical, and as shown in FIG. 4, indicate aspherical coefficients from fourth order to twentieth order, and indicate a conic constant and a radius of curvature Y. At least one or both of the seventh surface S7 and the eighth surface S8 may have a critical point from the optical axis OA to an end of an effective region. For example, the eighth surface S8 may have at least one critical point, and the critical point is a point at which the trend of a Sag value changes. That is, it is a point at which a Sag value increases and then decreases, or a point at which a Sag value decreases and then increases.

The fourth lens 104 may have the largest center thickness CT4 among the lenses. Since the fourth lens 104 is an aspherical glass lens closest to the image sensor 151 and has the largest thickness CT4, it is possible to prevent degradation in optical performance and to control an influence on aberration characteristics improvement and resolution. In addition, by disposing an aspherical lens as a lens closest to the image sensor 151, it is possible to be less sensitive to assembly tolerance as compared to a spherical lens. That is, being less sensitive to assembly tolerance means that even when assembled with a slight difference from a design, optical performance may not be significantly affected.

The center thickness CT1 of the first lens 101 may be thinner than center thicknesses CT2 and CT3 of the second and third lenses 102 and 103. An edge thickness ET1 of the first lens 101 may be the thickest among edge thicknesses of the lenses. The edge thickness ET1 of the first lens 101 may be greater than the center thicknesses CT1 and CT2 of the first and second lenses 101 and 102, and may be smaller than the center thicknesses CT3 and CT4 of the third and fourth lenses 103 and 104. Since the first lens 101 has the thickest thickness CT1 and has a meniscus shape convex towards the object on the optical axis OA, it is possible to suppress an increase in an effective diameter of the second surface S2 of the first lens 101 and to increase a center distance CG1 between the first and second lenses 101 and 102.

Since the second lens 102 has a meniscus shape convex towards the object, a center distance CG2 between the second lens 102 and the third lens 103 may be increased. In addition, in a region between the second lens 102 and the third lens 103, a center distance CG2 between the concave fourth surface S4 and the concave fifth surface S5 may be smaller than an edge distance.

Since the third lens 103 has a meniscus shape convex towards the sensor and the fourth lens 104 has a biconvex shape, a center distance CG3 between the third and fourth lenses 103 and 104 may be the smallest among center distances, and may be smaller than an edge distance between the third and fourth lenses 103 and 104.

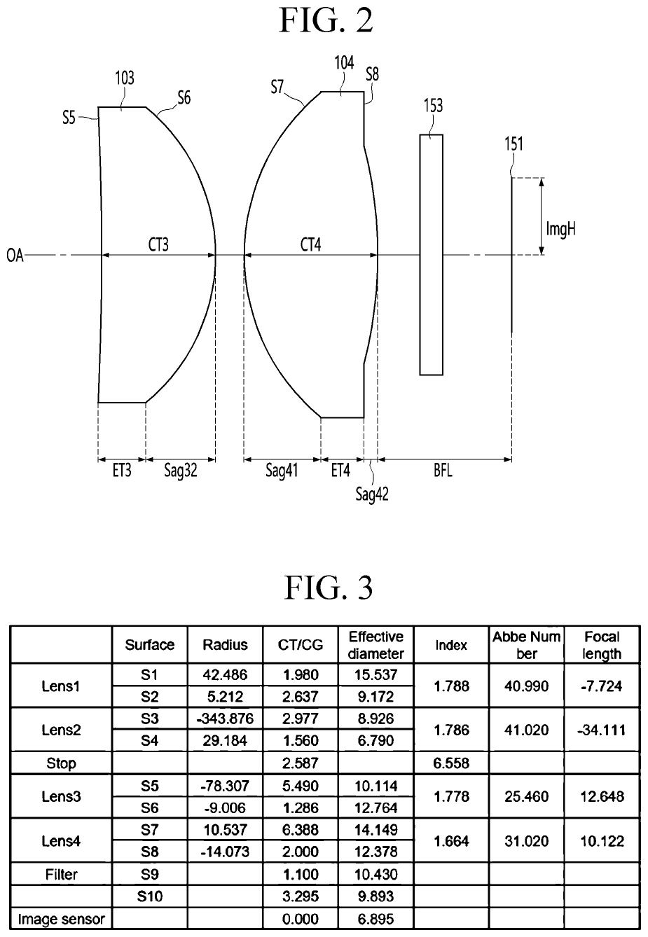

Referring to FIG. 2, an edge thickness ET3 of the third lens 103 may be smaller than the center thickness CT3 of the third lens 103. An edge thickness ET4 of the fourth lens 104 may be smaller than the center thickness CT4 of the fourth lens 104. The distance in the optical axis direction from a straight line, which passes through a center of the sensor-side sixth surface S6 of the third lens 103 and is orthogonal to the optical axis OA, to the sixth surface is Sag32, and a value of Sag32 may have a negative value, and may be 0.5 times or more of the center thickness CT3 of the third lens 103, for example, in a range of 0.5 times to 0.9 times.

A distance in the optical axis direction from a straight line, which passes through a center of the object-side the seventh surface S7 of the fourth lens 104 and is orthogonal to the optical axis OA, to the seventh surface S7 is Sag41, and a distance in the optical axis direction from a straight line which passes through a center of the sensor-side eighth surface S8 and is orthogonal to the optical axis OA, to the eighth surface S8 is Sag42, and a value of Sag41 has a positive value and a value of Sag42 has a negative value. In this manner, a Sag value of the object-side fifth surface S5 of the third lens 103 may be defined as Sag31 and has a negative value.

Here, a Max_Sag value is a maximum value among sag values and may have a maximum value at an edge of each lens. The sag value may have a negative value when the lens surface is located on the object-side from the straight line orthogonal to the center of the lens surface, and may have a positive value when the lens surface is located on the sensor-side from the straight line orthogonal to the center of the lens surface.

Maximum sag values of the third and fourth lenses 103 and 104 may satisfy the following conditions.

0<|Max_Sag31|<|Max_Sag32|<3 mm Condition 1:

|Max_Sag42|<Max_Sag32<|Max_Sag41| Condition 2:

|Max_Sag31|<|Max_Sag42| Condition 3:

BFL (Back focal length) is an optical-axis distance from the image sensor 151 to a center of a sensor-side surface of the lens closest to the image sensor 151, and may satisfy the following condition.

CT4<BFL Condition:

As shown in FIGS. 1 and 2, CT1, CT2, CT3, and CT4 are center thicknesses or optical-axis thicknesses of the first, second, third, and fourth lenses 101, 102, 103, and 104, and ET1, ET2, ET3, and ET4 are edge thicknesses in an optical axis direction at edges of the first, second, third, and fourth lenses 101, 102, 103, and 104. A center distance between the first and second lenses 101 and 102 is CG1, a center distance between the second and third lenses 102 and 103 is CG2, and a center distance between the third and fourth lenses 103 and 104 is CG3. Each edge thickness of each lens is an optical-axis-direction distance between an object-side surface and a sensor-side surface at an end of an effective region of each lens. The center thickness and the edge thickness of the lens may satisfy the following conditions.

CT1<CT2 Condition 1:

CT2<CT3<CT4 Condition 2:

CT12<CT3<CT13 Condition 3:

CT1<ET2<ET1 Condition 4:

CT1<ET4<ET1 Condition 5:

Each of effective diameters of the first lens 101 to the third lens 103 is an average of effective diameter of an object-side surface and a sensor-side surface and the effective diameters are defined as CA1, CA2, CA3, and CA4, and effective diameters of an object-side surface and a sensor-side surface of the first lens 101 to the fourth lens 104 may be defined as CA11, CA12, CA21, CA22, CA31, CA32, CA41, and CA42. When the aperture stop ST is disposed on the sensor-side surface of the second lens 102, the following conditions may be satisfied.

CA2<CA3<CA1 Condition 1:

(ImgH*2)<CA2<CA4 Condition 2:

CA1<CA4 Condition 3:

CA21<CA22<CA12<CA11 Condition 4:

CA22<CA31<CA32<CA41 Condition 5:

CA31<CA42<CA41 Condition 6:

Since the second lens 102 disposed on an object side of the aperture stop ST has negative power (F2<0) and has a meniscus shape convex toward an object, the second lens 102 may refract incident light in a direction closer to the optical axis. In addition, since the second and third lenses 102 and 103 have opposite meniscus shapes, an edge distance between the second and third lenses 102 and 103 may become smaller than the center distance CG2. Accordingly, the center distance CG2 between the second and third lenses 102 and 103 may gradually increase, thereby preventing degradation of yield by weight of the optical system and improving production efficiency. Here, it is possible to prevent an increase in an effective diameter of the third lens 103 disposed on a sensor side of the aperture stop ST, and it is possible to provide the camera module to be slim in thickness within an angle-of-view range.

FIG. 3 shows an example of lens data of an optical system according to an embodiment of FIG. 1. As shown in FIG. 3, radius of curvature at the optical axis OA of the first to fourth lenses 101, 102, 103, and 104, center thicknesses CT of the lenses, center distances CG between adjacent lenses, refractive indices at d-line, Abbe numbers, effective diameters, and focal lengths may be set. Here, the effective diameter may be defined as CA (clear aperture).

FIG. 4 shows aspherical coefficients of the third and fourth surfaces of the second lens and the seventh and eighth surfaces of the fourth lens. As shown in FIG. 4, the second and fourth lenses 102 and 104 may include a lens surface having twentieth-order aspherical coefficients. Since an aspherical surface having twentieth-order aspherical coefficients (non-zero values) may particularly greatly change an aspherical shape at a peripheral portion, it is possible to satisfactorily correct optical performance at a periphery of an angle of view.

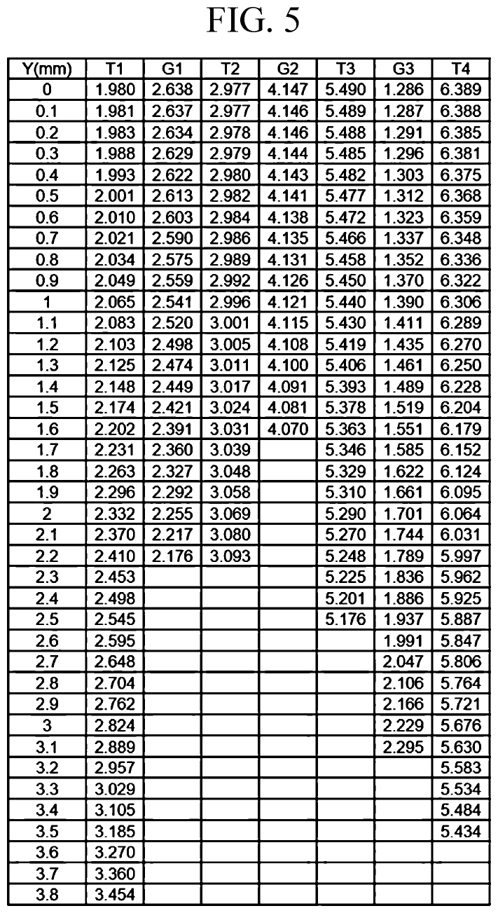

As shown in FIG. 5, thicknesses T1, T2, T3, and T4 of the first to fourth lenses 101, 102, 103, and 104 and distances G1, G2, and G3 between two adjacent lenses may be set. As shown in FIG. 5, in a Y-axis direction from the optical axis toward an edge of each lens, thicknesses T1, T2, T3, and T4 of each lens may be indicated at intervals of 0.1 mm or more, and each distance G1, G2, and G3 between adjacent lenses may be indicated at intervals of 0.1 mm or more as well.

As shown in FIG. 5, in case of the thickness T1 of the first lens 101, the center thickness may be the smallest and the edge thickness may be the greatest. In case of the thickness of T2 of the second lens 102, a difference between the center thickness and the edge thickness may be the smallest. In case of the thickness T3 of the third lens 103, the center thickness may be the thickest and the edge thickness may be the thinnest. In case of the thickness T4 of the fourth lens 104, the center thickness may be the thickest and the edge thickness may be the thinnest. In addition, in case of distance G1 between the first and second lenses, a center distance may be the greatest and an edge distance may be the smallest. In case of distance G2 between the second and third lenses, a center distance may be the greatest and an edge distance may be the smallest. In case of distance G3 between the third and fourth lenses, a center distance may be the smallest and an edge distance may be the greatest.

In describing thicknesses of the lenses, the center thickness CT1 of the first lens 101 may be smaller than the center thicknesses CT2 and CT3 of the second and third lenses 102 and 103. Preferably, a maximum thickness among the lenses is the center thickness CT4 of the fourth lens 104. Since the center thickness CT1 of the first lens 101 is thin as 3 mm or less and a radius of curvature of the sensor-side second surface S2 is provided to be minimum, light incident through the glass lens may be refracted to an end of an effective region of the last lens. A ratio of a center thickness to an edge thickness of each lens may satisfy the following conditions.

0.5<CT1/ET1<1 Condition 1:

0.5<CT2/ET2<1.5 Condition 2:

1.5<CT3/ET3<2.5 Condition 3:

1.7<CT4/ET4<2.7 Condition 4:

1<ΣCT/ΣET<1.5 Condition 5:

Here, a sum of center thicknesses of the lenses is ΣCT, and a sum of edge thicknesses is ΣET.

In addition, a difference between a maximum center thickness and a minimum center thickness among the lenses may be 3.5 mm or more, for example, in a range of 3.5 mm to 5.5 mm. In addition, since the difference between the center thickness and the edge thickness of each of the first and second lenses is not large, even when one of the first and second lenses is tilted, an influence on optical characteristics may be reduced. In addition, it is possible to reduce an influence on thermal characteristics between a center portion and an edge portion of the lenses.

Center distances between the first to fourth lenses 101, 102, 103, and 104 are defined as CG1, CG2, and CG3, and a sum of the center distances between the first to fourth lenses 101, 102, 103, and 104 may be defined as CG. The center distance CG3 between the third lens 103 and the fourth lens 104 is a center distance between a spherical lens and an aspherical lens, and may be smaller than the center distance CG1 between the first and second lenses 101 and 102.

Radii of curvature of the first and second surfaces S1 and S2 of the first lens 101 may be expressed as L1R1 and L1R2, Radii of curvature of the third and fourth surfaces S3 and S4 of the second lens 102 may be expressed as L2R1 and L2R2, Radii of curvature of the fifth and sixth surfaces S5 and S6 of the third lens 103 may be expressed as L3R1 and L3R2, and Radii of curvature of the seventh and eighth surfaces S7 and S8 of the fourth lens 104 may be expressed as L4R1 and L4R2. These radii of curvature are radii of curvature of respective lens surfaces on the optical axis and may satisfy at least one of the following conditions.

L1R2<L1R1 Condition 1:

L1R2<L2R2<|L2R1| Condition 2:

L1R2<|L3R2|<|L3R1|<|L2R1| Condition 3:

L4R1<|L4R2|<L2R2 Condition 4:

|L3R1|*2<|L2R1| Condition 5:

When the fourth lens 104 is designed as an aspherical lens, it is possible to satisfy thermal compensation and improve optical performance. In addition, by the aperture stop ST between the second and third lenses 102 and 103, it is possible to implement an optical system having a low CRA (chief ray angle).

The first to fourth lenses 101 to 104 may include a glass lens closest to the object side and may be provided with a center thickness of 1 mm or more. The first lens 101 made of glass has a small change amount such as contraction and movement of the lens as the ambient temperature changes from room temperature to low temperature or high temperature. Accordingly, even when the temperature changes, degradation in resolution is small as compared to a plastic lens. The first lens 101 disposed at a front end of the optical system being a glass lens having a high refractive index affects reducing a change amount of resolution of the entire optical system as the ambient temperature changes from room temperature to low temperature or high temperature. The last fourth lens 104 may apply an aspherical lens to prevent degradation in resolution due to temperature change.

The focal lengths F3 and F4 of the third and fourth lenses 103 and 104 have positive power, and the focal lengths F1 and F2 of the first and second lenses 101 and 102 may have negative power. Accordingly, when each lens repeats contraction and expansion as temperature changes from low temperature to high temperature, chromatic aberration may be corrected by glass lenses having high heat resistance.

When expressed as absolute values, a focal length of the second lens 102 is maximum among the lenses and may be 20 mm or more, for example, 25 mm or more. A focal length of the first lens 101 is minimum among the lenses. A difference between absolute values of the maximum focal length and the minimum focal length may be 35 mm or less. By making a difference between absolute values of focal lengths of the first and second lenses 101 and 102 greater than a difference between focal lengths of the third and fourth lenses 103 and 1-4, it is possible to have improved MTF characteristics, aberration control characteristics, resolution characteristics, and the like in an angle-of-view range set in the optical system, and it is possible to have good optical performance at a periphery of the angle of view.

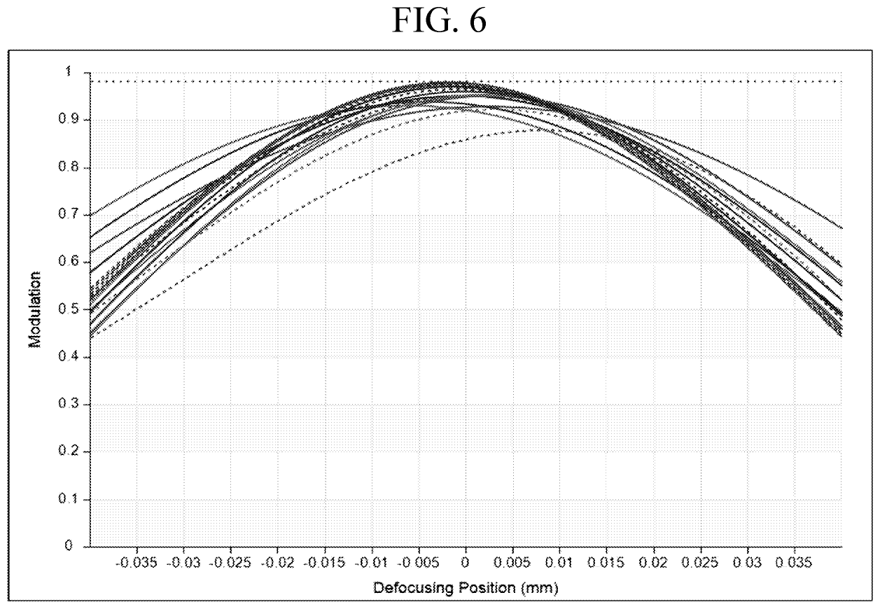

FIG. 6 is a graph showing diffraction MTF (Modulation Transfer Function) at room temperature in the optical system of FIG. 1, and is a graph showing modulation according to spatial frequency. As shown in FIG. 6, the x-axis indicates a defocusing position, the y-axis indicates MTF, and graphs from F1 to F11 are graphs measured from 0.000 mm to 3.441 mm in units of 0.344 mm.

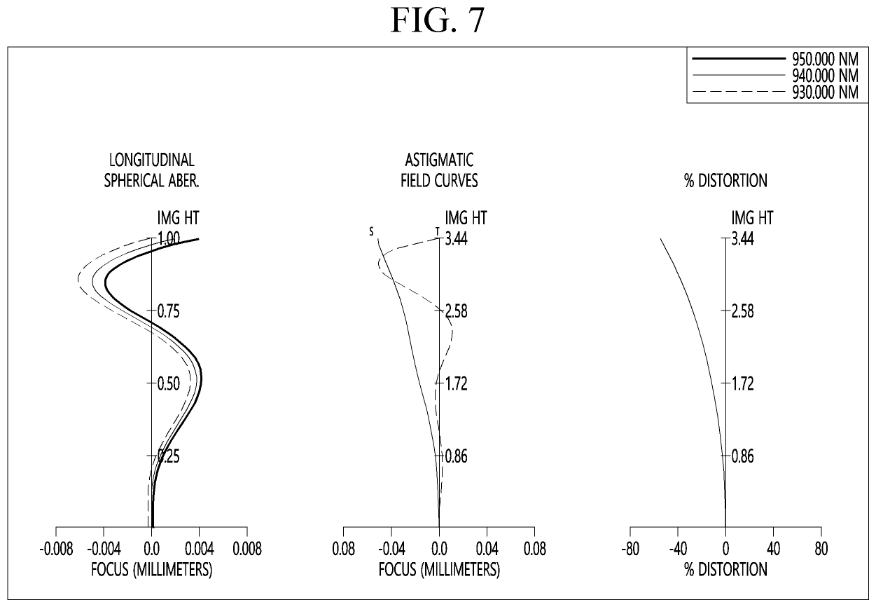

FIG. 7 is a graph showing aberration characteristics in the optical system of FIG. 1. In the aberration graph of FIG. 7, graphs measuring astigmatic field curves and distortion are shown from left to right. In FIG. 7, the x-axis may indicate a focal length (mm) and a distortion (%) and the y-axis may indicate an image height. In addition, the graphs for astigmatic aberration and distortion are graphs for light in wavelength bands of 930 nm, 940 nm, and 950 nm. In the aberration graph of FIG. 7, it may be interpreted that aberration correction performance is better as each curve is closer to the y-axis, and it can be seen that, in the optical system 100 according to the embodiment, measured values are close to the y-axis in almost all regions. That is, the optical system 100 according to the embodiment has improved resolution and may have good optical performance both at a center portion and a peripheral portion of the field of view (FOV). Here, a low temperature is −20 degrees or less, for example, in a range of −20 to −40 degrees, room temperature is in a range of 22 degrees±5 degrees or in a range of 18 degrees to 27 degrees, and a high temperature is 80 degrees or more, for example, in a range of 80 degrees to 105 degrees. Accordingly, it can be seen that a decrease in modulation from low temperature to high temperature is less than 10%, for example, 5% or less, or is hardly changed.

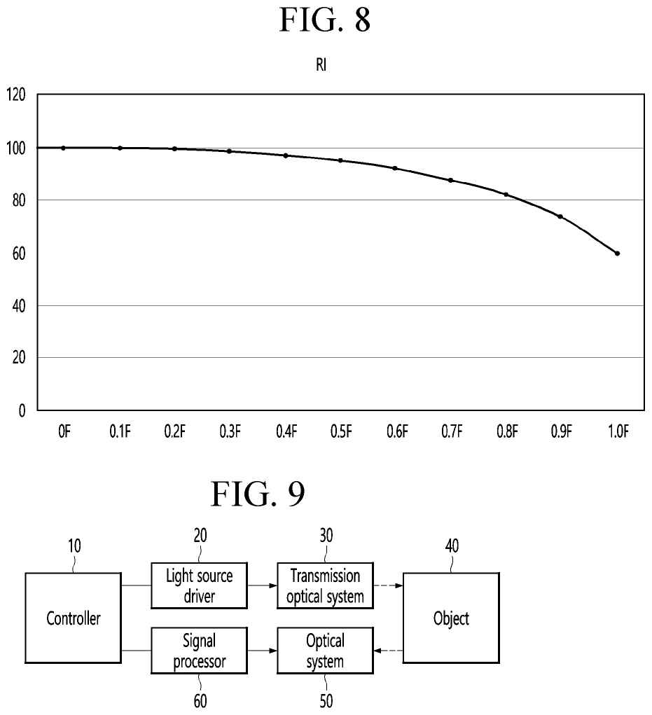

FIG. 8 is a graph illustrating relative illumination, or peripheral light quantity ratio, according to image height from the center (0 Field) to the edge (1.0 Field) of the image sensor in the optical system according to the embodiment. It can be seen from the graph that a relative illumination exceeding 60%, for example 64% or more, is achieved from the center of the image sensor to the diagonal end (1.0 Field). That is, it can be seen that there is almost no difference in peripheral illumination from an optical axis to an end of an effective region according to low temperature, room temperature, and high temperature. Accordingly, since a minimum light amount exceeds 60% from a center portion to an end portion of the image sensor, more accurate sensing values can be obtained in an entire region of the image sensor.

Even when using at least one aspherical lens, the optical system 100 may be designed such that temperature compensation for the aspherical lens is possible, and degradation in reliability of optical characteristics can be prevented. In addition, it can be seen that, even when temperature changes from room temperature to low temperature or high temperature, an effective focal length, TD, BFL, an F-number (F #), a diagonal field of view (FOV), and the like are hardly changed. Here, TD is an optical-axis distance from a center of an object-side surface of the first lens 101 to a center of a sensor-side surface of the last lens 104. When a center wavelength of an infrared wavelength is 940 nm±20 nm and a distance between the camera module and a subject at the first lens 101 of the camera module is 1530 mm, the optical system according to an embodiment can effectively control various aberration characteristics and can have good optical performance not only at a center portion of the field of view (FOV) but also at a peripheral portion.

The optical system 100 according to the embodiment disclosed above may satisfy at least one or two or more of the following equations described below. Accordingly, the optical system 100 according to the embodiment may have improved optical characteristics. For example, when the optical system 100 satisfies at least one equation, the optical system 100 can effectively control aberration characteristics such as chromatic aberration and distortion, and can have good optical performance not only at a center portion of the field of view (FOV) but also at a peripheral portion. In addition, the optical system 100 may have improved resolution. In addition, what is meant by thicknesses on the optical axis OA of the lenses and distances on the optical axis OA between adjacent lenses described in the equations may refer to the embodiments disclosed above.

0<CT1/CT2<1 [Equation 1]

Equation 1 can adjust chromatic aberration of the optical system by setting a difference between center thicknesses CT1 and CT2 of the first and second lenses to be small. Preferably, the present invention may satisfy 0.5<CT1/CT2<1. By setting the center thickness of each of the first and second lenses 101 and 102, optical performance at a center portion and a peripheral portion of the field of view (FOV) can be improved. Since the first and second lenses are made of glass, it is possible to prevent degradation in strength of the glass lenses, to optimize thermal compensation according to a temperature change from low temperature to high temperature, and to prevent degradation in optical performance.

5<CA11/CT1<15 [Equation 2]

CA11 is an effective diameter of the object-side surface S1 of the first lens. Since CA11 satisfies Equation 2, aberration characteristics of the optical system can be improved. Preferably, the present invention may satisfy 6<CA11/CT1<9. Since the first lens is made of glass and due to the effective diameter of the object-side surface, it is possible to prevent a decrease in an amount of incident light.

0.5<CT4/CT3<1.5 [Equation 3]

Equation 3 can set center thicknesses CT3 and CT4 of the third and fourth lenses. Equation 3 can improve chromatic aberration of the optical system by setting a difference between the center thicknesses CT3 and CT4 of the third and fourth lenses to be small. Preferably, the present invention may satisfy 1<CT4/CT3<1.3. Aberration characteristics and manufacturing precision can be improved by the center thicknesses of the third and fourth lenses.

1<CT4/(CT1+CT2)<2 [Equation 4]

Equation 4 can set center thicknesses of the first, second, and fourth lenses and can improve chromatic aberration of the optical system.

1<CT4/CG2<2 [Equation 5]

Equation 5 can set a relationship between a maximum center thickness among the lenses and a maximum center distance between adjacent lenses. Accordingly, a total track length TTL can be set using the maximum center thickness and the maximum center distance. Preferably, the present invention may satisfy 1.2<CT4/CG2<1.8.

1<CG1/CG2<2 [Equation 6]

In Equation 6, by setting the center distance CG1 between the first and second lenses and the center distance CG2 between the second and third lenses, a center distance between a spherical lens and an aspherical lens can be adjusted. Preferably, the present invention may satisfy 1.2<CG1/CG2<1.8.

CG0<CG1 [Equation 7]

In Equation 7, the center distance CG0 between the cover glass 155 and the first lens 101 can be set to be smaller than the center distance CG1 between the first and second lenses. Accordingly, the cover glass 155 can protect a surface of the first lens 101.

2<CT4/Nd1<5 [Equation 8]

In Equation 8, Nd1 is a refractive index at d-line of the first lens, and a refractive index of the glass material of the first lens 101 and the center thickness CT4 of the fourth lens can be set. Preferably, the present invention may satisfy 3<CT4/Nd1<4.

0.3<(CT3+CT4)/TD<0.8 [Equation 9]

TD is an optical-axis distance from a center of the first surface S1 on an object side of the first lens 101 to the eighth surface S8 on a sensor side of the last lens, that is, the fourth lens 104. Equation 9 can set center thicknesses of two thickest lenses among the lenses based on the total optical-axis distance TD of the lenses. Preferably, the present invention may satisfy 0.4<(CT3+CT4)/TD<0.55.

1.70<Nd1 [Equation 10]

In Equation 10, by setting the refractive index of the first lens 101 to be high, it is possible to adjust a factor affecting a reduction in third-order aberration (Seidel aberration) of the optical system, and to reduce aberration that may occur as TTL becomes somewhat long. Preferably, the present invention may satisfy 1.75<Nd1<2.1. When the present invention is designed to be lower than the lower limit of Equation 10, it is possible to obtain performance of reducing aberration, but refractive power of the first lens may be weakened and light may not be efficiently collected, so performance of the optical system may deteriorate. When the present invention is designed to be higher than the upper limit of the Equation, it is difficult to obtain a material. In addition, when the refractive index of the first lens 101 is designed to be lower than the lower limit of Equation 10, radii of curvature of the first and second lenses may be increased to increase refractive power of the first and second lenses.

0.5<Nd1/Nd3<1.5 [Equation 11]

Nd1 and Nd3 are refractive indices at d-line of the first and third lenses. In Equation 11, by reducing a refractive-index difference between the first and third lenses, it is possible to prevent degradation in color dispersion by the glass lenses. Preferably, the present invention may satisfy Nd3<Nd1.

0.5<Nd3/Nd4<1.5 [Equation 12]

Nd1 and Nd4 are refractive indices at d-line of the third and fourth lenses. In Equation 12, by setting refractive indices of the glass third and fourth lenses, it is possible to adjust color dispersion by spherical lenses and color dispersion by aspherical lenses. Preferably, the present invention may satisfy 1<Nd3/Nd4<1.2.

(Vd4Nd4)<(Vd1Nd1) [Equation 13]

Vd1 and Vd4 are Abbe numbers of the first and fourth lenses. In Equation 13, by setting a product of the refractive index and the Abbe number of the fourth lens 104 to be lower than a product of the refractive index and the Abbe number of the first lens 101, it is possible to adjust color dispersion by the spherical lens and color dispersion by the aspherical lens.

25 mm<TTL/D1 [Equation 14]

TTL is an optical-axis distance from a center of the object-side surface S1 of the first lens 101 to a surface of the image sensor 151, and D1 is an optical-axis distance from a sensor-side surface of the cover glass 155 to a surface of the image sensor 151. The present invention satisfying Equation 14 can protect the glass first lens by disposing the cover glass on the object-side surface of the first lens.

SD<TD/D1 [Equation 15]

In Equation 15, SD is an optical-axis-direction distance from an aperture stop to a sensor-side surface of the last lens, TD is an optical-axis distance from a center of the object-side surface of the first lens to a center of the sensor-side surface of the last lens, that is, the fourth lens, and D1 is an optical-axis distance from the sensor-side surface of the cover glass to a surface of the image sensor 151. Since the optical system satisfies Equation 15, a position of the aperture stop ST can be set. Preferably, the present invention may satisfy 31.01 mm<D1<35 mm.

0.7<BFL/CT4<1.2 [Equation 16]

In Equation 16, BFL is an optical-axis distance from the sensor-side surface of the last lens, that is, the fourth lens, to a surface of the image sensor 151. In Equation 16, a center thickness of the last lens and an optical-axis distance between the last lens and the image sensor can be set. Accordingly, the fourth lens can adjust an emitted light path. Preferably, the present invention may satisfy 0.8<BFL/CT4<1.1.

2<TTL/(CTn+CTn−1)<5 [Equation 17]

In Equation 17, center thicknesses of an n-th lens and an (n−1)-th lens can be set. Accordingly, center thicknesses of the third and fourth lenses can be set in the total optical-axis length of the optical system to adjust a path of emitted light. Preferably, the present invention may satisfy 2<TTL/(CT3+CT4)<3.

1<CA11/CA21<3 [Equation 18]

CA11 means an effective diameter of the first surface S1 on an object side of the first lens 101, and CA21 means an effective diameter of the third surface S3 on an object side of the second lens 102. When Equation 18 is satisfied, the optical system 100 can control incident light and set factors affecting aberration, and preferably, the present invention may satisfy 1.5<CA11/CA21<2.

0<CA22/CA31<1 [Equation 19]

CA22 means an effective diameter of the fourth surface S4 on a sensor side of the second lens, and CA31 means an effective diameter of the fifth surface S5 on an object side of the third lens. When Equation 19 is satisfied, the optical system 100 can control a light path traveling through between lens groups, and can set the sensor-side surface of the second lens to have a concave shape. Preferably, the present invention may satisfy 0.5<CA22/CA31<0.9.

0.5<CA32/CA41<1.5 [Equation 20]

CA32 means an effective diameter of the sixth surface S6 on a sensor side of the third lens, and CA41 means an effective diameter of the seventh surface S7 on an object side of the fourth lens. When Equation 20 is satisfied, the optical system 100 can adjust a light path traveling through the second lens group. Preferably, the present invention may satisfy 0.7<CA32/CA41<1.

1<CA11/CA42<3 [Equation 21]

CA11 is an effective diameter of the first surface S1 of the first lens, and CA42 means an effective diameter of the eighth surface S8 of the fourth lens. When the optical system 100 satisfies Equation 21, it is possible to increase an amount of incidence of the spherical first lens and to set a light path toward the image sensor through the last aspherical lens. Preferably, the present invention may satisfy 1<CA11/CA42<2.

0<CG2/(CT2+CT3)<1 [Equation 22]

Equation 22 can set a distance CG2 between the first and second lens groups LG1 and LG2 and center thicknesses of two adjacent lenses among lenses of the first and second lens groups LG1 and LG2. Accordingly, it is possible to refract light to an entire region of the image sensor 151 through the first lens group LG1 and the second lens group LG2. Preferably, the present invention may satisfy 0.3<CG2/(CT2+CT3)<0.8.

1<CA11/CA12<3 [Equation 23]

CA11 and CA12 are an average of effective diameters of an object-side surface and a sensor-side surface of the first lens. Since Equation 23 is satisfied, an increase in an effective diameter of the second lens can be suppressed by a difference between the effective diameters of the object-side surface and the sensor-side surface of the first lens. Preferably, the present invention may satisfy 1.2<CA11/CA12<2.

0<CG_Max/BFL<1 [Equation 24]

CG_Max is a maximum among optical-axis distances between two adjacent lenses and is, for example, an optical-axis distance between the second and third lenses 102 and 103. Preferably, CG_Max<BFL may be satisfied. Accordingly, it is possible to set the optical-axis distance BFL between the image sensor and the last lens to be greater than the maximum optical-axis distance between the lenses.

0.5<|F1|/BFL<1.5 [Equation 25]

In Equation 25, when the focal length F1 of the first lens and the optical-axis distance BFL between the last lens 104 and the image sensor 151 satisfy the condition, material and distance of the first lens and the last lens can be set. Preferably, the present invention may satisfy 1<|F1|/BFL<1.5.

10<L1R1/CT1<30 [Equation 26]

Equation 26 can set the radius of curvature L1R1 of the object-side surface of the first lens 101 to be more than ten times the center thickness of the first lens. Accordingly, an amount of light incident through the first lens can be increased. Preferably, the present invention may satisfy 15<L1R1/CT1<25.

2<|L3R1|/|L4R2|<8 [Equation 27]

In Equation 27, by setting the radius of curvature L3R1 of the object-side surface of the third lens 103 and the radius of curvature L4R2 of the object-side surface of the fourth lens 104, it is possible to facilitate correction of aberrations such as astigmatism, coma, and distortion and to increase design freedom.

1<|L4R2|/CT4<5 [Equation 28]

L4R2 is a radius of curvature of a sensor-side surface of the fourth lens. When Equation 28 is satisfied, refractive power of the fourth lens 104 can be controlled to improve optical performance, and processing of the fourth lens can be facilitated. Preferably, the present invention may satisfy 1<|L4R2|/CT4<3.

0<L4R2|/L4R1<5 [Equation 29]

When Equation 29 is satisfied, refractive power of the fourth lens 104 can be controlled to improve optical performance. Preferably, the present invention may satisfy 0<|L4R2|/L4R1<2.

5<|L1R1/L1R2|<12 [Equation 30]

In Equation 30, radii of curvature of the object-side surface and the sensor-side surface of the first lens can be set. When Equation 30 is satisfied, refractive power of the first lens 101 can be controlled to improve optical performance. Preferably, the present invention may satisfy 6<L1R1/L1R2<10.

5<|L2R1/L2R2|<20 [Equation 31]

L2R1 is a radius of curvature of an object-side surface of the second lens, and L2R2 is a radius of curvature of a sensor-side surface of the second lens. When Equation 31 is satisfied, refractive power of the second lens 102 can be controlled to improve optical performance, and effective diameters of the third and fourth lenses 103 and 104 can be adjusted. Preferably, the present invention may satisfy 8<L2R1/L2R21<15.

1<CT_Max/CG_Max<2 [Equation 32]

In Equation 32, a maximum center thickness CT_Max among the lenses and a maximum center distance CG_Max between adjacent lenses can be set. When Equation 32 is satisfied, the optical system can have good optical performance at a focal length of a set field of view and can adjust TTL. Preferably, the present invention may satisfy y 1.2<CT_Max/CG_Max<1.8.

1<ΣCT/ΣCG<3 [Equation 33]

ΣCT is a sum of center thicknesses of the lenses, and ΣCG is a sum of center distances between adjacent lenses. When Equation 33 is satisfied, the optical system can have good optical performance at a set field of view and focal length and can adjust TTL. Here, 1.5<ΣCT/ΣCG<2.5 may be satisfied.

5<ΣNd<10 [Equation 34]

ΣNd means a sum of refractive indices at d-line of a plurality of lenses. When Equation 34 is satisfied, TTL can be controlled and improved resolution can be obtained in the optical system 100 in which aspherical lenses and spherical lenses are mixed. In addition, when a number of spherical lenses is greater than a number of aspherical lenses, TTL and a sum of refractive indices can be set. Preferably, the present invention may satisfy 6<ΣNd<8.

10<ΣVd/ΣNd<50 [Equation 35]

ΣVd means a sum of Abbe numbers of the plurality of lenses. When Equation 35 is satisfied, the optical system 100 may have improved aberration characteristics and resolution. By setting a sum of Abbe numbers and a sum of refractive indices of the lenses in Equation 35, optical characteristics can be controlled, and preferably, the present invention may satisfy 15<ΣVd/ΣNd<25.

10<(ΣCTn)/F<30 [Equation 36]

n is a number of lenses of the optical system, and F is an effective focal length of the optical system. When Equation 36 is satisfied, TTL can be adjusted. Preferably, the present invention may satisfy 15<(ΣCTn)/F<25.

0<CT1/ET1<1 [Equation 37]

ET1 is an edge thickness of the first lens. When Equation 37 is satisfied, rigidity of the first glass lens can be protected. Preferably, the present invention may satisfy 0.2<CT1/ET1<0.6.

1<CA11/CA_Min<5 [Equation 38]

CA_Min indicates a minimum effective diameter among object-side surfaces and sensor-side surfaces of the lenses. When Equation 37 is satisfied, the optical system can control incident light, maintain optical performance, and provide a slimmer module. Preferably, the present invention may satisfy 1.5<CA11/CA_Min<3.

L3R1<0 [Equation 39]

In Equation 39, the object-side surface of the third lens may be provided in a concave shape.

CG3<|Max_Sag32|<CG2 [Equation 40]

Max_Sag32 indicates a maximum distance from a straight line orthogonal to a center of the sensor-side surface of the third lens to the sensor-side surface of the third lens. When Equation 40 is satisfied, a sag value of the sensor-side surface of the third lens can be set to be large. Preferably, the present invention may satisfy 2 mm<|Max_Sag32|<3 mm.

CG3<|Max_Sag41|<CG2 [Equation 41]

Max_Sag41 indicates a maximum distance from a straight line orthogonal to a center of the object-side surface of the fourth lens to the object-side surface of the fourth lens. When Equation 41 is satisfied, a sag value of the object-side surface of the fourth lens can be set to be large. Preferably, the present invention may satisfy 1.5 mm<Max_Sag41<2.5. In addition, the present invention may satisfy |Max_Sag32|<|Max_Sag41|.

1<CA_Max/(2ImgH)<6 [Equation 42]

In Equation 42, a maximum effective diameter CA_Max of a lens surface can be set as a diagonal length (2ImgH) of the image sensor 151, and when this is satisfied, the optical system can maintain good optical performance and a slim and compact sensor device can be set. Preferably, the present invention may satisfy 1<CA_Max/(2*ImgH)<3.

0<F/|L4R2|<1 [Equation 43]

F is an effective focal length of the optical system, and L4R2 is a radius of curvature of the sensor-side surface of the fourth lens. When Equation 43 is satisfied, by setting the effective focal length and the radius of curvature of the sensor-side surface of the last aspherical lens, reduction of the optical system, for example, an influence on TTL, can be adjusted. Preferably, the present invention may satisfy 0<F/|L4R2|<0.5.

0<F/L1R1<0.5 [Equation 44]

In Equation 44, by setting the effective focal length of the optical system and the radius of curvature of the object-side surface of the first lens, an influence on incident light and TTL can be adjusted. Preferably, the present invention may satisfy 0<F/L1R1<0.2.

0<EPD/|L4R2|<1 [Equation 45]

EPD means an entrance pupil diameter of the optical system 100. When the optical system 100 according to the embodiment satisfies Equation 45, the optical system 100 can control incident light. Preferably, the present invention may satisfy 0<EPD/|L4R2|<0.5.

0<EPD/L1R1<0.5 [Equation 46]

In Equation 46, an entrance pupil diameter of the optical system 100 and the radius of curvature L1R1 of the object-side surface of the first lens can be set, and when this is satisfied, the optical system 100 can control incident light. Preferably, the present invention may satisfy 0<EPD/L1R1<0.3.

1<|F2/F|<10 [Equation 47]

F2 is a focal length of the second lens. When Equation 47 is satisfied, negative power can be set for the second lens for an optical system having a field of view of 110 degrees or more. Preferably, the present invention may satisfy 2<|F2/F|<7.

1<|F1|/F<10 [Equation 48]

F1 is a focal length of the first lens, and F is an overall focal length. When Equation 48 is satisfied, negative power can be set for the first lens for an optical system having a field of view of 110 degrees or more.

0<|F1/F4|<2 [Equation 49]

In Equation 49, the focal length F1 of the first lens and the focal length F4 of the fourth lens can be set, and refractive power of the fourth lens can be controlled to improve resolution. Preferably, the present invention may satisfy 0.5<|F1/F4|<1. In Equations 47 to 49, when F1, F2, F3, and F4 and an overall effective focal length are set, by adjusting a focal length from the spherical lens to a focal length of the last aspherical lens, light can be guided to an effective region of the aspherical lens. A balance of focal lengths of the lenses can suppress a difference in a focus position due to a temperature change. Accordingly, it is possible to suppress degradation in optical characteristics of imaging lenses due to temperature change.

0.5<|F34|/F12<2 [Equation 50]

F12 is a composite focal length of the first and second lenses, and F34 is a composite focal length of the third and fourth lenses. The first and third lenses may have powers of opposite signs, thereby improving aberration, and light can be effectively guided to the aspherical lens. Preferably, the present invention may satisfy F12<0 and 0<F34. Preferably, the present invention may satisfy 1<|F34|/F12<1.5.

20 mm<TTL<60 mm [Equation 51]

TTL means an optical-axis distance from a center of the first surface S1 of the first lens 101 to an image surface of the image sensor 151. When Equation 51 is satisfied, the optical system can be applied to an automotive optical system having TTL. Preferably, the present invention may satisfy 20 mm<TTL<40 mm.

2 mm<ImgH<6 mm [Equation 52]

Equation 52 can set ½ of a diagonal size of the image sensor 151 and can provide an optical system having an automotive sensor size. Preferably, the present invention may satisfy 3 mm<ImgH<5 mm.

1.5 mm<BFL<8 mm [Equation 53]

In Equation 53, by setting BFL (Back focal length) to exceed 1.5 mm, an installation space for an optical filter can be secured, assembly of components can be improved through a distance between the image sensor 151 and the last lens, and coupling reliability can be improved. Preferably, the present invention may satisfy 4 mm<BFL<7.5 mm. When BFL is less than the range of Equation 53, resolution of the image sensor may decrease. When BFL exceeds the range of Equation 53, stray light may be introduced and aberration characteristics of the optical system may deteriorate.

1 mm<F<10 mm [Equation 54]

Equation 54 can set an overall effective focal length F to correspond to an automotive optical system. the present invention may satisfy 1 mm<F<6 mm.

80 degrees<FOV<160 degrees [Equation 55]

In Equation 55, FOV (Field of view) means a field of view (degree) of the optical system 100, and an automotive optical system having a field of view exceeding 80 degrees or a field of view of 100 degrees or more can be provided. Preferably, the present invention may satisfy 100<FOV<140. In Equation 55, a range of the automotive optical system can be set by the field of view. A sensor length in a horizontal direction is based on 6.4 mm+0.5 mm. In addition, when Equation 55 is satisfied, when temperature changes from room temperature to high temperature, a change rate of the effective focal length and a change rate of the field of view may be 5% or less, for example, in a range of 0 to 5%. In addition, even when using a mixture of aspherical lenses and spherical lenses in the optical system 100, it is possible to prevent degradation in optical characteristics through temperature compensation and aberration correction by a glass aspherical lens.

1<TTL/CA_Max<7 [Equation 56]

Equation 56 can provide an improved automotive optical system by setting the total optical-axis length of the optical system and a maximum effective diameter among object-side surfaces and sensor-side surfaces of the lenses. Preferably, the present invention may satisfy 1<TTL/CA_Max<3. In addition, the present invention may satisfy 50<CA_Max*n<80, where n is an overall number of lenses.

5<TTL/ImgH<12 [Equation 57]

Equation 57 can set the total optical-axis length TTL of the optical system and an image height ImgH which is a diagonal-direction length of the image sensor 151 from the optical axis. When the optical system 100 according to the embodiment satisfies Equation 57, the optical system 100 can have TTL for application of an automotive image sensor 151, thereby providing improved image quality. Preferably, Equation 57 may satisfy 7<TTL/ImgH<10.

1<BFL/ImgH<3 [Equation 58]

Equation 58 can set BFL which is an optical-axis distance between the image sensor 151 and the last lens and ½ of a maximum diagonal-direction length of the image sensor 151. When the optical system 100 according to the embodiment satisfies Equation 58, the optical system 100 can secure BFL for applying a size of the automotive image sensor 151, can set a distance between the last lens and the image sensor 151, and can have good optical characteristics at a center portion and a peripheral portion of the field of view. Preferably, the present invention may satisfy 1.5<BFL/ImgH<2.

2<TTL/BFL<10 [Equation 59]

Equation 59 can set the total optical-axis length TTL of the optical system and BFL which is an optical-axis distance between the image sensor 151 and the last lens. When the optical system 100 according to the embodiment satisfies Equation 59, the optical system 100 can secure BFL. Preferably, the present invention may satisfy 3<TTL/BFL<7.

5<TTL/F<15 [Equation 60]

Equation 60 can set the effective focal length F and the total optical-axis length TTL of the optical system 100. Accordingly, an optical system for a driver assistance system can be provided. Preferably, the present invention may satisfy 8<TTL/F<12. When the optical system 100 according to the embodiment satisfies Equation 60, the optical system 100 can have an appropriate focal length and a wide field of view within a set TTL range, and can provide an optical system that can maintain an appropriate focal length and form an image even when temperature changes from low temperature to high temperature. When the value of TTL/F is less than the lower limit of Equation 60, it is necessary to increase refractive power of the lenses, making it difficult to correct spherical aberration or distortion. When the value of TTL/F exceeds the upper limit of Equation 60, effective diameters or TTL of the lenses increase, causing a problem in that the imaging lens system becomes large.

0<F/BFL<1 [Equation 61]

Equation 61 can set the effective focal length F of the optical system 100 and BFL which is an optical-axis distance between the image sensor 151 and the last lens. When the optical system 100 according to the embodiment satisfies Equation 61, the optical system 100 can have a set field of view and an appropriate focal length and can be provided as an automotive optical system. In addition, the optical system 100 can minimize a distance between the last lens and the image sensor 151, thereby having good optical characteristics at a peripheral portion of the field of view. Preferably, the present invention may satisfy 0.4<F/BFL<0.7.

0.5<F/ImgH<1.5 [Equation 62]

Equation 62 can set the overall focal length F of the optical system 100 and the image height ImgH which is a diagonal length of the image sensor 151 from the optical axis. Such an optical system 100 can have improved aberration characteristics in a size of an automotive image sensor 151. Preferably, the present invention may satisfy 0.7<F/ImgH<1.

0.5<F/EPD<1.5 [Equation 63]

Equation 63 can set the overall focal length F and an entrance pupil diameter. Accordingly, the optical system has a small F-number and can control overall brightness. Preferably, the present invention may satisfy 0.7<F/EPD<1.

100<FOV/F#<200 [Equation 64]

Equation 64 can set a relationship between a diagonal field of view and an F-number of the optical system. Preferably, the present invention may satisfy 100<FOV/F #<130. Here, F # may be 1.2 or less to provide a bright image.

20<(CT_Max+CG_Max)/n<70 [Equation 65]

Equation 65 can set a maximum among center thicknesses of the lenses, a maximum among center distances between adjacent lenses, and a number of lenses n, and the present invention may satisfy 30<(CT_Max+CG_Max)/n<52.

600<(FOV*TTL)/n [Equation 66]

In Equation 66, when the field of view FOV and the total optical-axis length TTL of the optical system satisfy the condition, an optical-axis length of an optical system having a field of view of 110 degrees or more can be set. Accordingly, chromatic aberration, resolution, size, and the like of an optical system having five or fewer lenses can be controlled.

(TTL*n)<FOV [Equation 67]

Equation 67 indicates that a product of the total optical-axis length of the optical system and the number of lenses may be smaller than the field of view.

Z=cY^{2/1}+\sqrt{1−(1+K)c²Y²}+AY⁴BY⁶+CY⁸+DY¹⁰+EY¹²+FY¹⁴+ . . . [Equation 68]

In Equation 68, Z may represent a sag value and may indicate an optical-axis direction distance from an arbitrary position on an aspherical surface to a vertex of the aspherical surface. Y may indicate a distance in a direction perpendicular to the optical axis from an arbitrary position on the aspherical surface to the optical axis. c may represent a curvature of a lens, and K may represent a conic constant. In addition, A, B, C, D, E, and F may represent aspheric constants (aspheric coefficients).

The optical system 100 according to an embodiment may satisfy at least one, or two or more, among Equations 1 to 67. In this case, the optical system 100 may have improved optical characteristics. In particular, when the optical system 100 satisfies at least one among Equations 1 to 34 and/or at least one among Equations 35 to 67, the optical system 100 may provide improved resolution and may improve aberration and distortion characteristics. Further, the optical system 100 may secure a back focal length BFL for applying an in-vehicle image sensor 151, may compensate for degradation of optical characteristics due to a temperature change, and may minimize a distance between a last lens and the image sensor 151, thereby providing favorable optical performance in both a central region and a peripheral region of a field of view FOV.

Table 1 relates to items of the above-described equations for the optical system 100 of the embodiment, and includes TTL in mm, BFL in mm, effective focal length F, ImgH in mm, effective diameter in mm, a sum of center thicknesses of respective lenses, a sum of center distances between adjacent lenses, TTL in mm, a sum of Abbe numbers, a sum of refractive indices, TD in mm as an optical-axis distance from a first surface S1 to an eighth surface S8, focal lengths F1, F2, F3, and F4 of the first to fourth lenses, composite focal lengths, FOV, edge thickness ET, and an F-number.

TABLE 1

| Items | Values | Items | Values |
|---|---|---|---|
| F(EFL) | 3.134 | F12 | −5.747 |
| F1 | −7.724 | F34 | 6.389 |
| F2 | −34.111 | FOV | 135.07 |
| F3 | 12.648 | EPD | 3.396 |
| F4 | 10.122 | BFL | 6.395 |
| ΣNd | 7.015 | TD | 24.905 |
| ΣVd | 138.490 | ImgH | 3.448 |
| ΣCT | 16.835 | SD | 15.751 |
| ΣCG | 8.071 | ET1 | 3.999 |
| TTL | 31.012 | ET2 | 3.055 |
| F# | 0.923 | ET3 | 3.002 |
| ΣET | 13.067 | ET4 | 3.011 |

Table 2 shows result values for Equations 1 to 34 in the optical system 100 of the embodiment. Referring to Table 2, it can be seen that the optical system 100 satisfies at least one, two or more, or three or more among Equations 1 to 34. Accordingly, the optical system 100 may have favorable optical performance in both the central region and the peripheral region of the field of view FOV and may have excellent optical characteristics.

TABLE 2

| | |
|---|---|
| Equations | Values |

| | | |
|---|---|---|
| 1 | 0 < CT1/CT2 < 1 | 0.665 |
| 2 | 5 < CA11/CT1 < 15 | 7.847 |
| 3 | 0.5 < CT4/CT3 < 1.5 | 1.164 |
| 4 | 1 < CT4/(CT1 + CT2) < 2 | 1.289 |
| 5 | 1 < CT4/CG2 < 2 | 1.541 |
| 6 | 1 < CG2/CG1 < 2 | 1.572 |
| 7 | CG0 < CG1 | Satisfaction |
| 8 | 2 < CT4/Nd1 < 5 | 3.574 |
| 9 | 0.3 < (CT3 + CT4)/TD < 0.8 | 0.477 |
| 10 | 1.7 < Nd1 | 1.788 |
| 11 | 0.5 < Nd1/Nd3 < 1.5 | 1.006 |
| 12 | 0.5 < Nd3/Nd4 < 1.5 | 1.068 |
| 13 | (Vd4*Nd4) < (Vd1*Nd1) | Satisfaction |
| 14 | 25 mm < TTL < D1 | Satisfaction |
| 15 | SD < TD < D1 | Satisfaction |
| 16 | 0.7 < BFL/CT4 < 1.2 | 1.001 |
| 17 | 2 < TTL/(CTn + CTn − 1) < 5 | 2.611 |
| 18 | 1 < CA11/CA21 < 3 | 1.741 |
| 19 | 0 < CA22/CA31 < 1 | 0.671 |
| 20 | 0.5 < CA32/CA41 < 1.5 | 0.902 |
| 21 | 1 < CA11/CA42 < 5 | 1.255 |
| 22 | 0 < CG2/(CT2 + CT3) < 1 | 0.490 |
| 23 | 1 < CA11/CA12 < 3 | 1.694 |
| 24 | 0 < CG_Max/BFL < 1 | 0.648 |
| 25 | 0.5 < \|F1\|/BFL < 1.5 | 1.208 |
| 26 | 10 < L1R1/CT1 < 30 | 21.458 |
| 27 | 2 < \|L3R1\|/\|L4R2\| < 8 | 5.564 |
| 28 | 1 < \|L4R2\|/CT4 < 5 | 2.203 |
| 29 | 0 < \|L4R2\|/L4R1 < 5 | 1.335 |
| 30 | 5 < L1R1/L1R2 < 12 | 8.151 |
| 31 | 5 < \|L2R1\|/L2R2 < 20 | 11.783 |
| 32 | 1 < CT_Max/CG_Max < 2 | 1.541 |
| 33 | 1 < ΣCT/ΣCG < 3 | 2.086 |
| 34 | 5 < ΣNd < 10 | 7.015 |

Table 3 shows result values for Equations 35 to 67 in the optical system 100 of the embodiment. Referring to Table 3, it can be seen that the optical system 100 satisfies at least one, two or more, or three or more among Equations 35 to 67. Accordingly, the optical system 100 may have favorable optical performance in both the central region and the peripheral region of the field of view FOV and may have excellent optical characteristics.

TABLE 3

| | |
|---|---|
| Equations | Values |

| | | |
|---|---|---|
| 35 | 10 < ΣVd/ΣNd < 50 | 19.741 |
| 36 | 10 < (ΣCT*n)/F < 30 | 21.486 |
| 37 | 0 < CT1/ET1 < 1 | 0.495 |
| 38 | 1 < CA11/CA_Min < 5 | 2.288 |
| 39 | L3R1 < 0 | −78.307 |
| 40 | CG3 < \|Max_Sag32\| < CG2 | Satisfaction |
| 41 | CG3 < \|Max_Sag41\| < CG2 | Satisfaction |
| 42 | 1 < CA_Max/(2*ImgH) < 6 | 2.253 |
| 43 | 0 < F/\|L4R2\| < 1 | 0.223 |
| 44 | 0 < F/L1R1 < 0.5 | 0.074 |
| 45 | 0 < EPD/\|L4R2\| < 1 | 0.241 |
| 46 | 0 < EPD/L1R1 < 0.5 | 0.080 |
| 47 | 1 < \|F2/F1\| < 10 | 4.416 |
| 48 | 1 < \|F1\|/F < 10 | 2.465 |
| 49 | 0 < \|F1/F4\| < 2 | 0.763 |
| 50 | 0.5 < \|F34\|/F12 < 2 | 1.112 |
| 51 | 20 < TTL < 60 | 31.012 |
| 52 | 2 < ImgH < 6 | 3.448 |
| 53 | 1.5 < BFL < 8 | 6.395 |
| 54 | 1 < F < 10 | 3.134 |
| 55 | 80 < FOV < 160 | 135.067 |
| 56 | 1 < TTL/CA_Max < 7 | 1.996 |
| 57 | 5 < TTL/ImgH < 12 | 8.995 |
| 58 | 1 < BFL/ImgH < 3 | 1.855 |
| 59 | 2 < TTL/BFL < 10 | 4.850 |
| 60 | 5 < TTL/F < 15 | 9.895 |
| 61 | 0 < F/BFL < 1 | 0.490 |
| 62 | 0.5 < F/ImgH < 1.5 | 0.909 |
| 63 | 0.5 < F/EPD < 1.5 | 0.923 |
| 64 | 100 < FOV/F# < 200 | 146.351 |
| 65 | 20 < (CT_Max + CG_Max)*n < 70 | 42.140 |
| 66 | 600 < (FOV*TTL)/n | 1047.189 |
| 67 | (TTL*n) < FOV | Satisfaction |

FIG. 9 is a block diagram of a sensor device including the optical system according to an embodiment.

Referring to FIG. 9, the sensor device includes a controller 10, a light source driver 20, a transmission optical system 30, the optical system 50 for receiving light disclosed above, and a signal processor 60. The controller 10 controls transmission of signals and reception signals, and may be linked, based on transmitted and received signals, to devices related to an autonomous driving module, an artificial intelligence module, a drone, a robot, an augmented reality device, a virtual reality device, and communication services such as 5G and 6G. The light source driver 20 supplies power to and drives a light source included in the transmission optical system 30. The light source generates a laser beam in the form of a line light source or a point light source. The light source driver 20 may control or vary a drive current supplied to the light source according to driving environment information. The driving environment information may include terrain information of a driving section, traffic congestion information, weather, and the like.

A wavelength of the laser beam generated from the light source may be in a range of 890 nm to 960 nm or in a range of 940 nm±10 nm. Alternatively, the wavelength of the laser beam may be 1550 nm±10 nm. The laser light source may be implemented as an InGaAs/GaAs-based semiconductor diode laser and may emit a high-power laser beam. The light source may include a single emitter and/or multiple emitters.

The transmission optical system 30 transmits the laser beam generated from the light source to an object 40 through a lens unit and a diffuser, and light reflected from the object 40 is received by the optical system 50. The optical system 50 may include a plurality of optical sensors, and each optical sensor converts received light into an electrical signal using a photodiode. That is, a sensing unit is arranged in a matrix type so as to convert, into current, light received from the object scanned in each of a horizontal direction and a vertical direction.

The signal processor 60 converts an output of the optical system 50 into a voltage and amplifies the voltage, and then converts the amplified signal into a digital signal using an analog-to-digital converter. The signal processor 60 analyzes the digital data using a time-of-flight algorithm or a phase-shift algorithm to sense a distance to the object 40 and an object shape.

The controller 10 may receive vehicle speed information and road surface state information through an electronic control unit ECU or a network. The controller 10 may receive driving environment information through the network. The driving environment information may include terrain information of a driving section, traffic congestion information, weather, and the like. The controller 10 may adjust gain based on one or more of vehicle speed, road surface state of a road on which the vehicle travels, and driving environment information, and may provide sensor data including distance information and shape information of the object to an autonomous driving device.

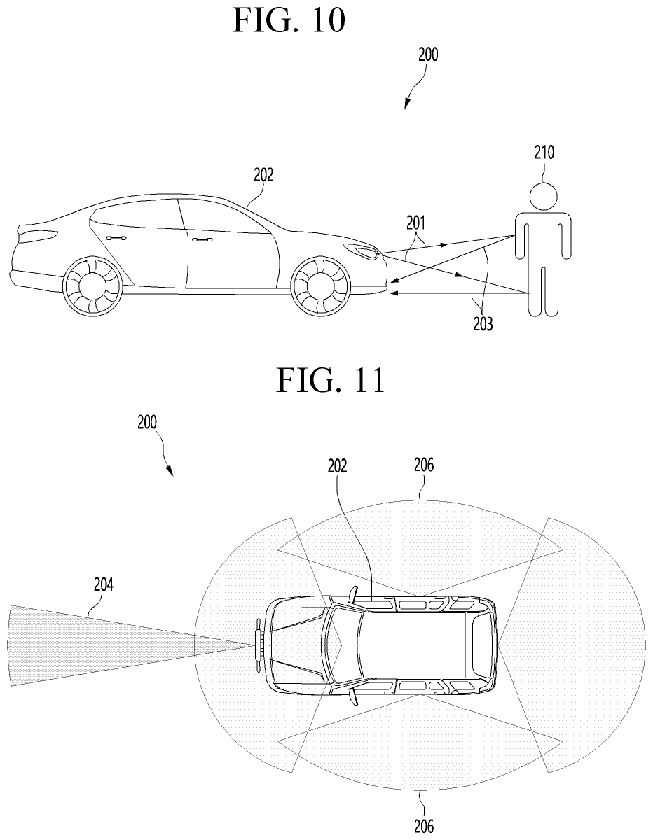

FIG. 10 illustrates an example of measuring an object in a vehicle including a sensor system of the invention, and FIG. 11 illustrates an example of surrounding monitoring in a vehicle including the sensor system of the invention.

Referring to FIGS. 10 and 11, a vehicle 202 including the sensor system includes a transmission optical system that projects a laser beam 201 generated by a light source toward a target scene, and a reception optical system that receives reflected light 203 reflected from a target or object 210. The sensor system includes a LIDAR system, and the LIDAR system typically includes a controller that calculates distance information about the object 210 from the reflected light, and also includes an element capable of scanning or providing a specific pattern of light, which may be a static pattern, within a desired range and field of view FOV. The transmission optical system is used to convert received signal light into measurement values representing a point-by-point three-dimensional map of a surrounding environment within the range and the field of view of the LIDAR system.

A LIDAR optical system and a signal processor calculate range information based on a time-of-flight measurement value of a light pulse emitted from the light source. In addition, information known about a light beam profile, based on illuminating a scene onto a target surface associated with a specific range and based on a particular design of a source and a projector system, is used to determine position information about a reflective surface, thereby generating a complete x, y, z three-dimensional picture of the scene. In other words, a point-by-point 3D map of the surrounding environment represents a collection of measurement data indicating position information from all surfaces that reflect illumination from a source to a receiver within the field of view of the LIDAR system. In this manner, a three-dimensional representation of an object is obtained within the field of view of the LIDAR system.

A schematic diagram also illustrates two-dimensional field-of-view and range requirements of a typical surround-sensing LIDAR system 200 for the vehicle 202. For example, an adaptive cruise control function may have a narrower field of view than a surround-view field of view and range 206, but may require a field of view and range 204 having a long-distance range requirement. In general, sensing functions of a vehicle may be enabled by a combination of LIDAR, radar, cameras, and ultrasonic sensors. A combination of sensor data that generates information about the surrounding environment is often referred to as sensor fusion. Although the invention describes the LIDAR system in the context of automobiles for autonomous driving, self-driving, or driver-assistance vehicles in which LIDAR is widely used, it should be understood that embodiments may be applied to any vehicle. Other types of vehicles include robots, tractors, trucks, airplanes, unmanned aerial vehicles, boats, and ships.

Features, structures, and effects described in the above embodiments are included in at least one embodiment of the invention and are not necessarily limited to only one embodiment. Further, features, structures, and effects exemplified in each embodiment may be combined with or modified for other embodiments by a person having ordinary skill in the art. Therefore, contents related to such combinations and modifications should be construed as being included in the scope of the invention.

In addition, although the embodiments have been described above, the embodiments are merely examples and do not limit the invention. A person having ordinary skill in the art would understand that various modifications and applications not illustrated above are possible without departing from essential characteristics of the embodiments. For example, each component specifically shown in the embodiments may be modified and implemented. Differences related to such modifications and applications should be construed as being included in the scope of the invention as defined in the appended claims.

What is claimed is:

1. An optical system comprising:
first to fourth lenses aligned on an optical axis from an object side toward a sensor side,
wherein each of the first to fourth lenses has an object-side surface and a sensor-side surface,
wherein a power of the first lens is negative,
wherein the object-side surface of the first lens has a convex shape on the optical axis,
wherein the object-side surface and the sensor-side surface of the first lens are spherical on the optical axis,
wherein the object-side surface and the sensor-side surface of the fourth lens are aspherical on the optical axis,
wherein a center distance between the first lens and the second lens is greater than an edge distance, and
wherein the object-side surface and the sensor-side surface of the fourth lens have convex shapes on the optical axis.

2. The optical system of claim 1, wherein the object-side surface of the third lens has a concave shape on the optical axis.

3. The optical system of claim 2, wherein the sensor-side surface of the second lens has a concave shape on the optical axis, and
wherein a center distance between the second lens and the third lens is greater than a center thickness of the second lens.

4. The optical system of claim 1, wherein the second lens has a negative power on the optical axis, and
wherein the sensor-side surface of the second lens has a minimum effective diameter among effective diameters of the object-side surfaces and the sensor-side surfaces of the first to fourth lenses.

5. The optical system of claim 1, wherein the object-side surface of the first lens has a maximum effective diameter among effective diameters of the object-side surfaces and the sensor-side surfaces of the first to fourth lenses.

6. The optical system of claim 1, wherein a composite focal length of the first lens and the second lens is negative, and
wherein an absolute value of the composite focal length of the first lens and the second lens is smaller than a composite focal length of the third lens and the fourth lens.

7. The optical system of claim 1, wherein:
a center thickness of the first lens is CT1,
center thickness of the second lens is CT2,
a center thickness of the fourth lens is CT4, and
wherein the following Equation satisfies: 1<CT4/(CT1+CT2)<2.

8. The optical system of claim 1, wherein, among absolute values of radii of curvature on the optical axis of the object-side surfaces and the sensor-side surfaces of the first to fourth lenses, the absolute value of the radius of curvature of the object-side surface of the second lens is greatest.

9. An optical system comprising:
first to fourth lenses aligned on an optical axis from an object side toward a sensor side,
wherein each of the first to fourth lenses has an object-side surface and a sensor-side surface,
wherein a power of the first lens is negative,
wherein the object-side surface of the first lens has a convex shape on the optical axis,
wherein the first lens is a spherical glass lens,
wherein the fourth lens is an aspherical glass lens,
wherein a center distance between the first lens and the second lens is greater than an edge distance,
wherein a center thickness of the third lens is greater than center thicknesses of the first lens and the second lens, and
wherein the object-side surface and the sensor-side surface of the fourth lens have convex shapes on the optical axis.

10. The optical system of claim 9, wherein the third lens has a positive power and the fourth lens has a positive power.

11. The optical system of claim 10, wherein the object-side surface of the third lens has a concave shape on the optical axis,
wherein the sensor-side surface of the second lens has a concave shape on the optical axis, and
wherein the center distance between the second lens and the third lens is greater than the center thickness of the second lens.

12. The optical system of claim 9, wherein the second lens has a negative power on the optical axis,
wherein the sensor-side surface of the second lens has a minimum effective diameter among effective diameters of the object-side surfaces and the sensor-side surfaces of the first to fourth lenses, and
wherein the object-side surface of the first lens has a maximum effective diameter among effective diameters of the object-side surfaces and the sensor-side surfaces of the first to fourth lenses.

13. The optical system of claim 9, wherein a center thickness of the fourth lens is thicker than center thicknesses of the first lens to the third lens.

14. The optical system of claim 9, wherein a focal length of the first lens is smaller than focal lengths of the second lens to the fourth lens,
wherein a composite focal length of the first lens and the second lens is negative, and
wherein an absolute value of the composite focal length of the first lens and the second lens is smaller than a composite focal length of the third lens and the fourth lens.

15. The optical system of claim 9, wherein a refractive index of the first lens is greater than 1.70, and
wherein a center thickness of the fourth lens is thicker than a sum of center thicknesses of the first lens and the second lens.

16. The optical system of claim 9, wherein:
a center thickness of the fourth lens is CT4,
a center thickness of the third lens is CT3,
an optical-axis distance from a center of the object-side surface of the first lens to a surface of an image sensor is TTL, and
wherein the following Equation satisfies: 2<TTL/(CT4+CT3)<5.

17. A camera module comprising:
a cover glass;
an image sensor;
a first lens group adjacent to the cover glass and aligned on an optical axis and having a spherical lens and an aspherical lens; and
a second lens group disposed between the first lens group and the image sensor and aligned on the optical axis and having a spherical lens and an aspherical lens,
wherein the cover glass is disposed between an object and the first lens group,
wherein a power of the first lens group is negative,
wherein a power of the second lens group is positive,
wherein, an object-side surface of a first lens closest to the cover glass in the first lens group has a convex shape on the optical axis,
wherein the object-side surface and a sensor-side surface of the first lens are spherical on the optical axis,
wherein a center distance between the first lens group and the second lens group is greater than an edge distance and is greatest among center distances between lenses of the first lens group and the second lens group, and
wherein an object-side surface and a sensor-side surface of a last lens closest to the image sensor have convex shapes on the optical axis.

18. The camera module of claim 17, wherein lenses of the first lens group and the second lens group are made of glass, and
wherein a center distance between the cover glass and the first lens is smaller than the center distance between the first lens group and the second lens group.

19. The camera module of claim 17, wherein an optical-axis distance from a center of the object-side surface of the first lens to a surface of the image sensor is TTL,
wherein an optical-axis distance from a sensor-side surface of a last lens closest to the image sensor to a surface of the image sensor is BFL, and
wherein the following Equations satisfy: 20 mm<TTL<60 mm and 2<TTL/BFL<10.

20. The camera module of claim 17, wherein the first lens group includes the first lens and a second lens disposed on a sensor side of the first lens,
wherein the second lens group is disposed on a sensor side of the second lens and includes a third lens and a fourth lens disposed on a sensor side of the third lens,
wherein a power of the first lens is negative,
wherein the first lens is made of glass,
wherein the fourth lens is a last lens and is made of glass,
wherein a center thickness of the third lens is greater than center thicknesses of the first lens and the second lens, and
wherein a radius of curvature of an object-side surface of the second lens is greatest among absolute values of radii of curvature on the optical axis of object-side surfaces and sensor-side surfaces of the first lens to the fourth lens.
